(19) United States
(12) Patent Application Publication
(10) Pub. No.: US 2024/0340059 A1
(43) Pub. Date: Oct. 10, 2024

(54) METHOD AND DEVICE FOR ENERGY SAVING IN WIRELESS COMMUNICATION SYSTEM

(71) Applicant: Samsung Electronics Co., Ltd., Suwon-si (KR)

(72) Inventors: Junyung YI, Suwon-si (KR); Youngbum KIM, Suwon-si (KR); Kyoungmin PARK, Suwon-si (KR); Jaewon LEE, Suwon-si (KR)

(21) Appl. No.: 18/628,115

(22) Filed: Apr. 5, 2024

(30) Foreign Application Priority Data
Apr. 7, 2023 (KR) 10-2023-0046031

(51) Int. Cl. H04B 7/06; H04W 72/1273

(52) U.S. Cl. CPC H04B 7/0626; H04B 7/0632; H04W 72/1273

(57) ABSTRACT

The disclosure relates to a 5th generation (5G) or 6th generation (6G) communication system for supporting a higher data transmission rate. A method performed by a terminal is provided. The method includes receiving, by the terminal from a base station, channel state information (CSI) report configuration information including a configuration on a CSI report for a network energy saving, a power offset for the CSI report for the network energy saving being included in the configuration on the CSI report for the network energy saving, obtaining, by the terminal, a channel quality indicator (CQI) based on the power offset, and transmitting, by the terminal to the base station, a CSI report including the CQI.

### CROSS-REFERENCE TO RELATED APPLICATION(S)

This application is based on and claims priority under 35 U.S.C. § 119(a) of a Korean patent application number 10-2023-0046031, filed on Apr. 7, 2023, in the Korean Intellectual Property Office, the disclosure of which is incorporated by reference herein in its entirety.

### BACKGROUND

### 1. Field

The disclosure relates to a method and a device for energy saving in a wireless communication system.

### 2. Description of Related Art

5th generation (5G) mobile communication technologies define broad frequency bands to provide higher transmission rates and new services, and may be implemented in “Sub 6 gigahertz (GHz)” bands such as 3.5 GHz, and also in “above 6 GHz” bands, which may be referred to as millimeter wave (mmWave) bands including 28 GHz and 39 GHz. In addition, the implementation of 6th generation (6G) mobile communication technologies (e.g., beyond 5G systems) in terahertz (THz) bands (e.g., 95 GHz to 3 THz bands) has been proposed in order to achieve transmission rates fifty times faster than 5G mobile communication technologies and ultra-low latencies one-tenth of 5G mobile communication technologies.

Since the beginning of the development of 5G mobile communication technologies, in order to support various services and to satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings (SCSs)) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio (NR)-Unlicensed (U) aimed at system operations conforming to various regulation-related requirements in unlicensed bands, NR user equipment (UE) power saving, non-terrestrial network (NTN), which is UE-satellite direct communication for providing coverage in an area in which communication with terrestrial networks is unavailable, and positioning.

There has also been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR).

There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, an exponentially increasing number of connected devices will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), and the like, 5G performance improvement and complexity reduction by utilizing artificial intelligence (AI) and machine learning (ML), AI service support, metaverse service support, and drone communication.

Such development of 5G mobile communication systems will serve as a basis for developing new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), and also full-duplex technologies for increasing frequency efficiency of 6G mobile communication technologies and improving system networks, AI-based communication technologies for implementing system optimization by utilizing satellites and AI from the design stage and internalizing end-to-end AI support functions, and next-generation distributed computing technologies for implementing services at levels of complexity exceeding the limit of UE operation capability by utilizing ultra-high-performance communication and computing resources.

With the recent development of 5G/6G communication systems in consideration of the environment, needs for methods to reduce energy consumption of base stations are on the rise.

The above information is presented as background information only to assist with an understanding of the disclosure. No determination has been made, and no assertion is made, as to whether any of the above might be applicable as prior art with regard to the disclosure.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods for reducing energy consumption of a base station in a wireless communication system, such as a method for channel state information (CSI) reference resource determination during spatial domain adaptation (SD adaptation) & power domain adaptation (PD adaptation) of a base station, a method for determining a power control offset and a channel quality indicator (CQI) table according to a target block error rate (BLER) for CQI calculation.

Another aspect of the disclosure is to provide, for energy saving of a base station, an SD adaptation method of turning off spatial & power elements (e.g., an antenna element (AE), a power amplifier (PA), an antenna port, or an antenna panel) of a base station, and a method for efficient CSI resource and CSI resource set configuration and CSI report configuration via higher-layer signaling (RRC) to apply SD adaptation. In this case, a new method for determining a CSI reference resource for a CSI report, based on information configured for the network energy saving (NES), and a new CQI calculation method according to a channel state information reference signal (CSI-RS) power change according to SD adaptation are provided. In addition, since the disclosure is to save energy of a base station during an NES mode, a CQI table may be determined based on a lower target BLER. Accordingly, a base station may perform CQI calculation and appropriate CSI reference resource determination during SD & PD adaptation for energy saving.

Additional aspects will be set forth in part in the description which follows and, in part, will be apparent from the description, or may be learned by practice of the presented embodiments.

In accordance with an aspect of the disclosure, a method performed by a terminal is provided. The method includes receiving, by the terminal from a base station, channel state information (CSI) report configuration information including a configuration on a CSI report for a network energy saving, a power offset for the CSI report for the network energy saving being included in the configuration on the CSI report for the network energy saving, obtaining, by the terminal, a channel quality indicator (CQI) based on the power offset, and transmitting, by the terminal to the base station, a CSI report including the CQI.

In accordance with another aspect of the disclosure, a method performed by a base station is provided. The method includes receiving, by the base station to a terminal, channel state information (CSI) report configuration information including a configuration on a CSI report for a network energy saving, a power offset for the CSI report for the network energy saving being included in the configuration on the CSI report for the network energy saving, and receiving, by the base station from the terminal, a CSI report including a channel quality indicator (CQI), wherein the CQI is based on the power offset.

In accordance with another aspect of the disclosure, a terminal is provided. The terminal includes transceivers, memory storing one or more computer programs, and one or more processors communicatively coupled to the transceivers and the memory, wherein the one or more computer programs include computer-executable instructions that, when executed by the one or more processors, cause the terminal to receive, from a base station, channel state information (CSI) report configuration information including a configuration on a CSI report for a network energy saving, a power offset for the CSI report for the network energy saving being included in the configuration on the CSI report for the network energy saving, obtain a channel quality indicator (CQI) based on the power offset, and transmit, to the base station, a CSI report including the CQI.

In accordance with another aspect of the disclosure, a base station is provided. The base station includes transceivers, memory storing one or more computer programs, and one or more processors communicatively coupled to the transceivers and the memory, wherein the one or more computer programs include computer-executable instructions that, when executed by the one or more processors, cause the base station to receive, to a terminal, channel state information (CSI) report configuration information including a configuration on a CSI report for a network energy saving, a power offset for the CSI report for the network energy saving being included in the configuration on the CSI report for the network energy saving, and receive, from the terminal, a CSI report including a channel quality indicator (CQI), wherein the CQI is based on the power offset.

In accordance with another aspect of the disclosure, one or more non-transitory computer-readable storage media storing one or more computer programs including computer-executable instructions that, when executed by one or more processors of a terminal, cause the terminal to perform operations are provided. The operations include receiving, by the terminal from a base station, channel state information (CSI) report configuration information including a configuration on a CSI report for a network energy saving, a power offset for the CSI report for the network energy saving being included in the configuration on the CSI report for the network energy saving, obtaining, by the terminal, a channel quality indicator (CQI) based on the power offset, and transmitting, by the terminal to the base station, a CSI report including the CQI.

Via embodiments of the disclosure, by defining methods of CSI reference resource determination and CQI calculation for a CSI report, during PD adaptation and SD adaptation for turning off a spatial element of a base station in a 5G system, a problem of excessive energy consumption of a base station may be solved, and appropriate CSI-RS measurements and CQI calculation may be performed.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency resources as a radio resource domain in a wireless communication system to which the disclosure is applied according to an embodiment of the disclosure;

FIG. 2 is a diagram illustrating a slot structure considered in a wireless communication system to which the disclosure is applied according to an embodiment of the disclosure;

FIG. 3 is a diagram illustrating an example of a beam sweeping operation and a time domain mapping structure of a synchronization signal, to which the disclosure is applied according to an embodiment of the disclosure;

FIG. 4 is a diagram illustrating a synchronization signal block considered in a wireless communication system, to which the disclosure is applied according to an embodiment of the disclosure;

FIG. 5 is a diagram illustrating various transmission cases of a synchronization signal block in a frequency band below 6 GHz considered in the communication system, to which the disclosure is applied according to an embodiment of the disclosure;

FIG. 6 is a diagram illustrating transmission cases of a synchronization signal block in a frequency band of 6 GHz or higher considered in the wireless communication system, to which the disclosure is applied according to an embodiment of the disclosure;

FIG. 7 is a diagram illustrating transmission cases of a synchronization signal block according to a subcarrier spacing within 5 milliseconds (ms) in the wireless communication system, to which the disclosure is applied according to an embodiment of the disclosure;

FIG. 8 is a diagram illustrating demodulation reference signal (DMRS) patterns (type1 and type2) used for communication between a base station and a terminal in the wireless communication system, to which the disclosure is applied according to an embodiment of the disclosure;

FIG. 9 is a diagram illustrating an example of channel estimation using a DMRS received from one physical uplink shared channel (PUSCH) in a time band of the wireless communication system, to which the disclosure is applied according to an embodiment of the disclosure;

FIG. 10 is a diagram illustrating an example of a method of reconfiguring synchronization signal block (SSB) transmission via dynamic signaling in the wireless communication system, to which the disclosure is applied according to an embodiment of the disclosure;

FIG. 11 is a diagram illustrating a method of reconfiguring a BWP and a BW via dynamic signaling in the wireless communication system, to which the disclosure is applied according to an embodiment of the disclosure;

FIG. 12 is a diagram illustrating a method of reconfiguring discontinuous reception (DRX) via dynamic signaling in the wireless communication system, to which the disclosure is applied according to an embodiment of the disclosure;

FIG. 13 is a diagram illustrating a discontinuous transmission (DTx) method for base station energy saving in the wireless communication system, to which the disclosure is applied according to an embodiment of the disclosure;

FIG. 14 is a diagram for illustrating an operation of a base station according to a gNode B (gNB) wake-up signal in the wireless communication system, to which the disclosure is applied according to an embodiment of the disclosure;

FIG. 15 is a diagram illustrating an antenna adaptation method of a base station to save energy in the wireless communication system, to which the disclosure is applied according to an embodiment of the disclosure;

FIG. 16A is a diagram illustrating an example of receiving CSI feedback for each terminal to determine SD adaptation of a base station in the wireless communication system, to which the disclosure is applied according to an embodiment of the disclosure;

FIG. 16B is a diagram illustrating an example of receiving CSI feedback for each terminal to determine SD adaptation of a base station in the wireless communication system, to which the disclosure is applied according to an embodiment of the disclosure;

FIG. 17A is a diagram illustrating an example of a method of CSI resource/resource set/report configuration for each terminal to determine SD adaptation by a base station in the wireless communication system, to which the disclosure is applied according to an embodiment of the disclosure;

FIG. 17B is a diagram illustrating another example of a method of CSI resource/resource set/report configuration for each terminal to determine SD adaptation by a base station in the wireless communication system, to which the disclosure is applied according to an embodiment of the disclosure;

FIG. 17C is a diagram illustrating another example of a method of CSI resource/resource set/report configuration for each terminal to determine SD adaptation by a base station in the wireless communication system, to which the disclosure is applied according to an embodiment of the disclosure;

FIG. 18 is a diagram illustrating a method of determining a CSI reference resource for energy saving by a base station in the wireless communication system, to which the disclosure is applied according to an embodiment of the disclosure;

FIG. 19 is a diagram illustrating a method of determining a physical downlink shared channel (PDSCH) transmission power via a power control offset by a terminal in the wireless communication system, to which the disclosure is applied according to an embodiment of the disclosure;

FIG. 20 is a diagram illustrating an example of a terminal operation of applying an energy saving method of the wireless communication system, to which the disclosure is applied according to an embodiment of the disclosure;

FIG. 21 is a diagram illustrating an example of a base station operation of applying an energy saving method of the wireless communication system, to which the disclosure is applied according to an embodiment of the disclosure;

FIG. 22 is a block diagram of a terminal according to an embodiment of the disclosure; and

FIG. 23 is a block diagram of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Furthermore, the size of each element does not completely reflect the actual size. In the respective drawings, the same or corresponding elements are provided with the same or corresponding reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, “A/B/C” may be understood as at least one of A, B, and C.

In the following description, a base station is an entity that allocates resources to terminals, and may be at least one of a gNode B, an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or long term evolution advanced (LTE-A) systems may be described by way of example, but the embodiments of the disclosure may also be applied to other communication systems having similar technical backgrounds or channel types to the embodiments of the disclosure. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, may be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession are in fact executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

Hereinafter, embodiments of the disclosure will be described in detail in conjunction with the accompanying drawings. Although methods and devices as described below in the embodiments of the disclosure are proposed as an example of methods and devices for improving uplink coverage when performing a random access procedure, the methods and devices are not limited to the respective embodiments, and may be applied to methods for configuring frequency resources corresponding to other channels, by using all or some of one or more embodiments in combination. Therefore, based on determinations by those skilled in the art, the embodiments of the disclosure may be applied to other communication systems through some modifications without significantly departing from the scope of the disclosure.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

A wireless communication system is advancing to a broadband wireless communication system for providing high-speed and high-quality packet data services using communication standards, such as high-speed packet access (HSPA) of third generation partnership project (3GPP), LTE-Advanced (LTE-A), LTE-Pro, high-rate packet data (HRPD) of 3GPP2, ultra-mobile broadband (UMB), Institute of Electrical and Electronics Engineers (IEEE) 802.17e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (hereinafter UE) (or a mobile station (MS)) transmits data or control signals to a base station (BS or eNode B (eNB)), and the downlink indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may requires wider coverage than those of other services provided by the 5G communication system because the UEs are likely to be located in a shadow area, such as a basement of a building, which is not covered by the cell due to the nature of the service. The UE supporting mMTC must be configured to be inexpensive, and may requires a very long battery life-time, such as 10 to 16 years, because it is difficult to frequently replace the battery of the UE.

Lastly, ultra-reliable low-latency communication (URLLC) is a cellular-based mission-critical wireless communication service. For example, URLLC is used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10⁵ or less. Therefore, for the services supporting URLLC, a 5G system must provide a transmit time interval (TTI) shorter than those of other services, and must also assign a large number of resources in a frequency band in order to secure reliability of a communication link.

The three services in the 5G communication system (hereinafter may be interchangeably used with “5G system”), that is, eMBB, URLLC, and mMTC, may be multiplexed and transmitted in a single system. In order to satisfy different requirements of the respective services, different transmission/reception techniques and transmission/reception parameters may be used between the services.

Hereinafter, a frame structure of a 5G system will be described in detail with reference to the drawings. Hereinafter, a configuration of a 5G system will be described as an example of a wireless communication to which the disclosure is applied for the sake of descriptive convenience, but the embodiments of the disclosure may also be applied in the same or similar manner to 5G or higher systems or other communication systems to which the disclosure is applicable.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth© chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

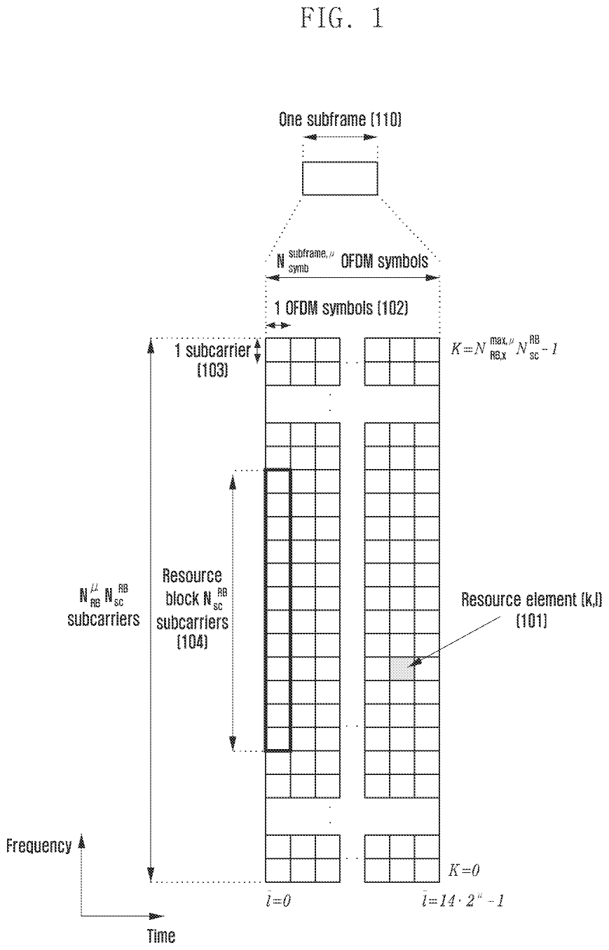

FIG. 1 illustrates a basic structure of a time-frequency resources as a radio resource domain in a wireless communication system to which the disclosure is applied according to an embodiment of the disclosure.

Referring to FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{sc}^{RB} (indicating the number of subcarriers per resource block (RB), for example, 12) consecutive REs constitutes one resource block (RB) 104. Also, in the time domain, N_{symb}^{subframe} (indicating the number of symbols per subframe) consecutive OFDM symbols may constitute one subframe 110.

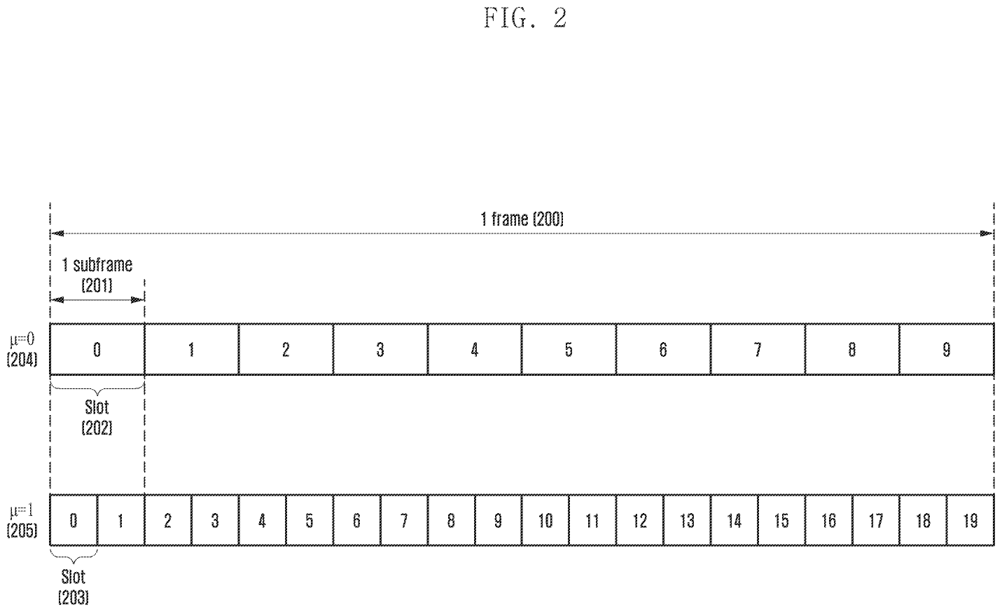

FIG. 2 illustrates a slot structure considered in a wireless communication system to which the disclosure is applied according to an embodiment of the disclosure.

Referring to FIG. 2, an example of a slot structure including a frame 200, a subframe 201, and a slot 202 is illustrated. One frame 200 may be defined as 10 ms. One subframe 201 may be defined as 1 ms, and thus one frame 200 may include a total of 10 subframes 201. One slot 202 or 203 may be defined as 14 OFDM symbols (that is, the number of symbols per one slot, N_{symb}^{slot}=14). One subframe 201 may include one or multiple slots 202 and 203, and the number of slots 202 and 203 per one subframe 201 may differ depending on a configuration values p 204 and 205 for the subcarrier spacing 204 or 205.

FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe Nₛₗₒₜ^{subframe,μ} may differ depending on the subcarrier spacing configuration value p, and the number of slots per one frame Nₛₗₒₜ^{frame,μ} may differ accordingly. Nₛₗₒₜ^{suframe,μ} and Nₛₗₒₜ^{frame,μ} may be defined according to each subcarrier spacing configuration p as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the 5G wireless communication system, a synchronization signal block (SSB) (SS block or SS/physical broadcast channel (PBCH) block may be interchangeably used) for initial access of a terminal may be transmitted, and the synchronization signal block may include a primary synchronization signal (PSS), a secondary synchronization signal (SSS), and a physical broadcast channel (PBCH).

During an initial access operation of a terminal accessing a system, the terminal may first acquire downlink time and frequency domain synchronization from a synchronization signal via a cell search and may acquire a cell ID. The synchronization signal may include a PSS and an SSS. In addition, the terminal may receive, from a base station, a PBCH for transmitting of a master information block (MIB) so as to acquire a basic parameter value and system information related to transmission and reception, such as a system bandwidth or related control information. Based on this information, the terminal may perform decoding on a physical downlink control channel (PDCCH) and a physical downlink shared channel (PDSCH) so as to acquire a system information block (SIB). The SIB may include at least one of uplink cell bandwidth-related information, a random-access parameter, a paging parameter, or an uplink power control-related parameter.

Then, the terminal may exchange terminal identification-related information with the base station via a random-access operation, and may initially access a network via registration and authentication operations. Additionally, the terminal may receive system information (system information block (SIB)) transmitted by the base station, so as to acquire control information related to cell common transmission and reception. The cell-common transmission and reception-related control information may include random-access-related control information, paging-related control information, common control information for various physical channels, and the like.

A synchronization signal is a signal that serves as a reference for a cell search, and for each frequency band, a subcarrier spacing appropriate for a channel environment, such as phase noise, may be applied. For a data channel or a control channel, in order to support various services as described above, a subcarrier spacing may be applied differently depending on a service type.

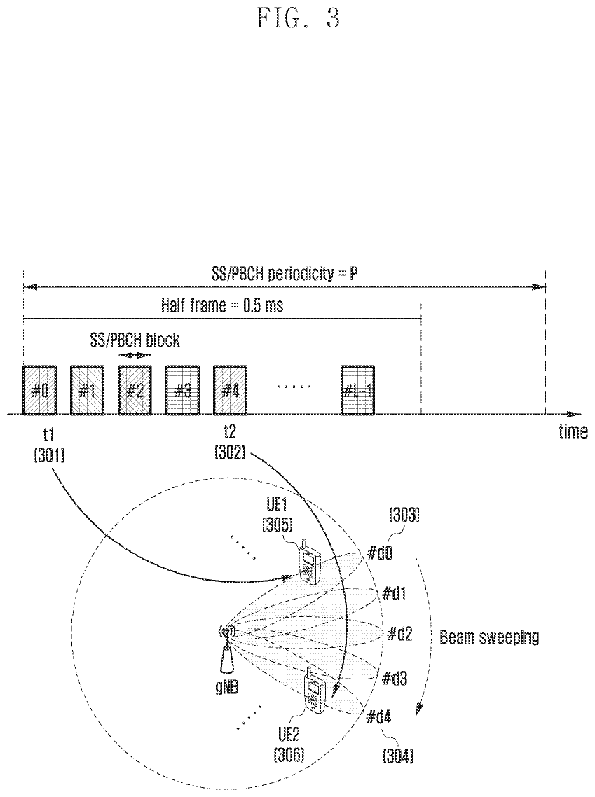

FIG. 3 is a diagram illustrating an example of a beam sweeping operation and a time domain mapping structure of a synchronization signal, to which the disclosure is applied according to an embodiment of the disclosure.

For description purposes, the following elements may be defined.
Primary synchronization signal (PSS): A PSS is a signal that serves as a reference for DL time/frequency synchronization, and provides some of cell identification (ID) information.
Secondary synchronization signal (SSS): An SSS serves as a reference for DL time/frequency synchronization, and provides some of the remaining cell ID information. Additionally, the SSS may serve as a reference signal for demodulation of a PBCH.
Physical broadcast channel (PBCH): A PBCH provides a master information block (MIB) which is essential system information required for transmission and reception of a data channel and a control channel of a terminal. The essential system information may include search space-related control information indicating radio resource mapping information of a control channel, scheduling control information for a separate data channel for transmission of system information, information such as a system frame number (SFN) which is a frame unit index that serves as a timing standard, and the like.
SS/PBCH block: An SS/PBCH block is configured by N OFDM symbols and may include a combination of a PSS, an SSS, a PBCH, and the like. For a system to which a beam sweeping technology is applied, an SS/PBCH block is a minimum unit to which beam sweeping is applied. In the 5G system, N=4 may be satisfied. A base station may transmit up to L SS/PBCH blocks, and the L SS/PBCH blocks are mapped within a half frame (0.5 ms). In addition, the L SS/PBCH blocks are periodically repeated in each predetermined period P. The base station may inform a terminal of period P via signaling. If there is no separate signaling for period P, the terminal may apply a previously agreed default value.

Referring to FIG. 3, FIG. 3 illustrates an example in which beam sweeping is applied in units of SS/PBCH blocks over time. In an example of FIG. 3, terminal 1 305 receives an SS/PBCH block by using a beam emitted in direction #d0 303, by beamforming applied to SS/PBCH block #0 at time point t1 301. In addition, terminal 2 306 receives an SS/PBCH block by using a beam emitted in direction #d4 304, by beamforming applied to SS/PBCH block #4 at time point t2 302. The terminal may acquire, from the base station, an optimal synchronization signal via a beam emitted in a direction where the terminal is located. For example, it is difficult for terminal 1 305 to acquire time/frequency synchronization and essential system information from the SS/PBCH block via the beam emitted in direction #d4 which is far from the position of terminal 1.

In addition to the initial access, the terminal may receive an SS/PBCH block also for determining whether a radio link quality of a current cell is maintained at a certain level or higher. In addition, during handover in which the terminal moves access from the current cell to an adjacent cell, the terminal may determine a radio link quality of the adjacent cell and receive an SS/PBCH block of the adjacent cell to acquire time/frequency synchronization of the adjacent cell.

Hereinafter, initial cell access operations of the 5G wireless communication system will be described in more detail with reference to drawings.

A synchronization signal is a signal that serves as a reference for a cell search, and may be transmitted by applying of a subcarrier spacing appropriate for a channel environment (e.g., phase noise) for each frequency band. A 5G base station may transmit multiple synchronization signal blocks according to the number of analog beams to be operated. A PSS and an SSS may be mapped and transmitted over 12 RBs, and a PBCH may be mapped and transmitted over 24 RBs. Hereinafter, a description will be provided for a structure in which a synchronization signal and a PBCH are transmitted in the 5G communication system.

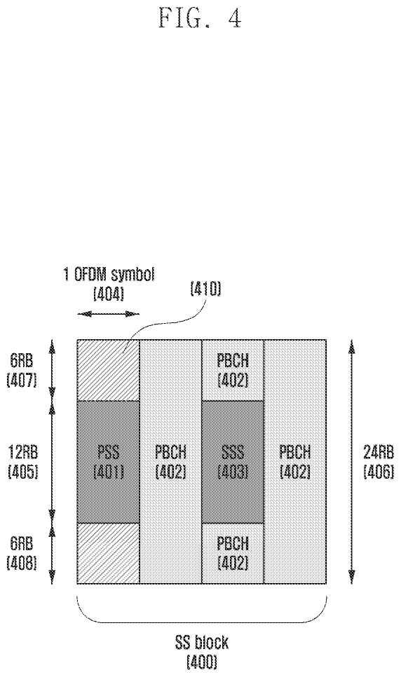

FIG. 4 is a diagram illustrating a synchronization signal block considered in the wireless communication system, to which the disclosure is applied according to an embodiment of the disclosure.

According to FIG. 4, a synchronization signal block (SS block) 400 may include a PSS 401, an SSS 403, and a PBCH 402.

The synchronization signal block 400 may be mapped to four OFDM symbols 404 on the time axis. The PSS 401 and the SSS 403 may be transmitted in 12 RBs 405 on the frequency axis, and in first and third OFDM symbols, respectively, on the time axis. In the 5G system, for example, a total of 1008 different cell IDs are defined. Depending on a physical layer cell ID (physical cell ID (PCI)) of a cell, the PSS 401 may have 3 different values, and the SSS 403 may have 336 different values. Via detection for the PSS 401 and the SSS 403, based on a combination thereof, a terminal may acquire one of 1008 (336×3=1008) cell IDs. This may be expressed by Equation 1.

$${N}_{ID}^{cell} = 3 {N}_{ID}^{( 1 )} + {N}_{ID}^{( 2 )} \qquad Equation 1$$

Here, N_{ID}⁽¹⁾ may be estimated from the SSS 403, and may have a value between 0 and 335. N_{ID}⁽²⁾ may be estimated from the PSS 401 and may have a value between 0 and 2. The terminal may estimate a value of N_{ID}^{(cell)}, which is a cell ID, by using a combination of N_{ID}⁽¹⁾ and N_{ID}⁽²⁾.

In 24 RBs 406 on the frequency axis and in a second or a fourth OFDM symbol of the SS block on the time axis, the PBCH 402 may be transmitted in resources including 6 RBs 407 and 6 RBs 408 on both sides, excluding 12 RBs 405 in the middle where the SSS 403 is transmitted. The PBCH 402 may include a PBCH payload and a PBCH demodulation reference signal (DMRS), and various system information referred to as MIB may be transmitted in the PBCH payload. For example, an MIB includes information as in Table 2 below.

TABLE 2

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}

Synchronization signal block information: An offset of the frequency domain of the synchronization signal block may be indicated via 4-bit ssb-SubcarrierOffset in an MIB. The terminal may indirectly acquire an index of the synchronization signal block including the PBCH via decoding of the PBCH and the PBCH DMRS. In an embodiment, in a frequency band below 6 GHz, 3 bits acquired via decoding of the PBCH DMRS may indicate the synchronization signal block index, and in a frequency band of 6 GHz or higher, a total of 6 bits, which includes 3 bits acquired via decoding of the PBCH DMRS and 3 bits which are included in the PBCH payload and acquired from PBCH decoding, may indicate the synchronization signal block index including the PBCH.
Physical downlink control channel (PDCCH) configuration information: A subcarrier spacing of a common downlink control channel may be indicated via 1 bit (subCarrierSpacingCommon) in an MIB, and time-frequency resource configuration information of a control resource set (CORESET) and a search space (SS) may be indicated via 8 bits (pdcch-ConfigSIB1).
System frame number (SFN): In an MIB, 6 bits (systemFrameNumber) may be used to indicate a part of an SFN. 4 bits (least significant bit (LSB)) of the SFN may be included in the PBCH payload and indirectly acquired by the terminal via PBCH decoding.
Timing information in a radio frame: Timing information is 1 bit (half frame) which is included in the aforementioned synchronization signal block index and PBCH payload, and acquired via PBCH decoding, and the terminal may indirectly identify whether the synchronization signal block has been transmitted in a first or second half frame of a radio frame.

The transmission bandwidth (12 RBs 405) for the PSS 401 and the SSS 403 is different from the transmission bandwidth (24 RBs 406) for the PBCH 402, so that, in a first OFDM symbol in which the PSS 401 is transmitted within the PBCH 402 transmission bandwidth, there exist 6 RBs 407 and 6 RBs 408 on both sides excluding 12 RBs while the PSS 401 is being transmitted, and the area may be used for transmitting another signal or may be empty.

Synchronization signal blocks may be transmitted using the same analog beam. For example, the PSS 401, the SSS 403, and the PBCH 402 are all transmitted via the same beam. Since analog beams cannot be applied differently to the frequency axis, the same analog beam may be applied to all frequency axis RBs within a specific OFDM symbol to which a specific analog beam has been applied. For example, the four OFDM symbols on which the PSS 401, the SSS 403, and the PBCH 402 are all transmitted via the same analog beam.

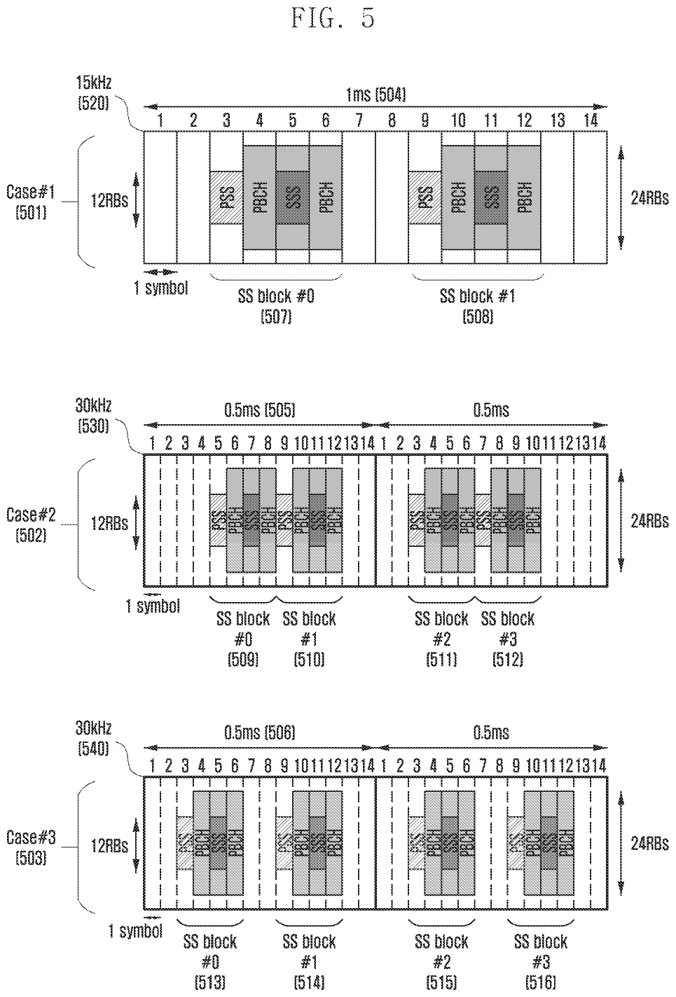

FIG. 5 is a diagram illustrating various transmission cases of a synchronization signal block in a frequency band below 6 GHz considered in the communication system, to which the disclosure is applied according to an embodiment of the disclosure.

Referring to FIG. 5, in the 5G communication system, a subcarrier spacing 520 of 15 kilohertz (kHz) and a subcarrier spacing 530 or 540 of 30 kHz may be used for synchronization signal block transmission in a frequency band of 6 GHz or lower. There may be one transmission case (e.g., case #1 501) for a synchronization signal block in the subcarrier spacing 520 of 15 kHz, and there may be two transmission cases (e.g., case #2 502 and case #3 503) for a synchronization signal block in the subcarrier spacing 530 or 540 of 30 kHz.

In FIG. 5, in case #1 501 with the subcarrier spacing 520 of 15 kHz, up to 2 synchronization signal blocks may be transmitted in 1 ms of time 504 (or corresponding to a length of 1 slot when 1 slot includes 14 OFDM symbols). In an example of FIG. 4, synchronization signal block #0 507 and synchronization signal block #1 508 are illustrated. For example, synchronization signal block #0 507 is mapped to 4 consecutive symbols starting from a third OFDM symbol, and synchronization signal block #1 508 may be mapped to 4 consecutive symbols starting from a ninth OFDM symbol.

Different analog beams may be applied to synchronization signal block #0 507 and synchronization signal block #1 508. In addition, the same beam may be applied to all of the third to sixth OFDM symbols to which synchronization signal block #0 507 is mapped, and the same beam may be applied to all of the ninth to 12th OFDM symbols to which synchronization signal block #1 508 is mapped. With regard to beams to be used for seventh, eighth, 13th, and 14th OFDM symbols to which no synchronization signal block is mapped, an analog beam may be freely determined at the discretion of a base station.

In FIG. 5, in case #2 502 with the subcarrier spacing 530 of 30 kHz, up to 2 synchronization signal blocks may be transmitted in 0.5 ms of time 505 (or corresponding to a length of 1 slot when 1 slot includes 14 OFDM symbols), and accordingly, up to 4 synchronization signal blocks may be transmitted in 1 ms of time (or corresponding to a length of 2 slots when 1 slot includes 14 OFDM symbols). In an example of FIG. 5, a case where synchronization signal block #0 509, synchronization signal block #1 510, synchronization signal block #2 511, and synchronization signal block #3 512 are transmitted in 1 ms of time (i.e., two slots) is illustrated. Synchronization signal block #0 509 and synchronization signal block #1 510 may be mapped starting from a 5th OFDM symbol and a 9th OFDM symbol of a first slot, respectively, and synchronization signal block #2 511 and synchronization signal block #3 512 may be mapped starting from a 3rd OFDM symbol and a 7th OFDM symbol of a second slot, respectively.

Different analog beams may be applied to synchronization signal block #0 509, synchronization signal block #1 510, synchronization signal block #2 511, and synchronization signal block #3 512, respectively. In addition, the same analog beam may be applied to all of fifth to eighth OFDM symbols of a first slot in which synchronization signal block #0 509 is transmitted, ninth to 12th OFDM symbols of the first slot in which synchronization signal block #1 510 is transmitted, third to sixth symbols of a second slot in which synchronization signal block #2 511 is transmitted, and seventh to 10th symbols of the second slot in which synchronization signal block #3 512 is transmitted. With regard to beams to be used for OFDM symbols to which no synchronization signal block is mapped, analog beams may be freely determined at the discretion of a base station.

In FIG. 5, in case #3 503 with the subcarrier spacing 540 of 30 kHz, up to 2 synchronization signal blocks may be transmitted in 0.5 ms of time 506 (or corresponding to a length of 1 slot when 1 slot includes 14 OFDM symbols), and accordingly, up to 4 synchronization signal blocks may be transmitted in 1 ms of time (or corresponding to a length of 2 slots when 1 slot includes 14 OFDM symbols). In an example of FIG. 5, transmission of synchronization signal block #0 513, synchronization signal block #1 514, synchronization signal block #2 515, and synchronization signal block #3 516 in 1 ms of time (i.e., two slots) is illustrated. Synchronization signal block #0 513 and synchronization signal block #1 514 may be mapped starting from a third OFDM symbol and a ninth OFDM symbol of a first slot, respectively, and synchronization signal block #2 515 and synchronization signal block #3 516 may be mapped starting from a third OFDM symbol and a ninth OFDM symbol of a second slot, respectively.

Different analog beams may be used for synchronization signal block #0 513, synchronization signal block #1 514, synchronization signal block #2 515, and synchronization signal block #3 516, respectively. As described in the examples above, the same analog beam may be used for all 4 OFDM symbols in which respective synchronization signal block are transmitted, and in OFDM symbols to which no synchronization signal block is mapped, beams to be used may be freely determined at the discretion of a base station.

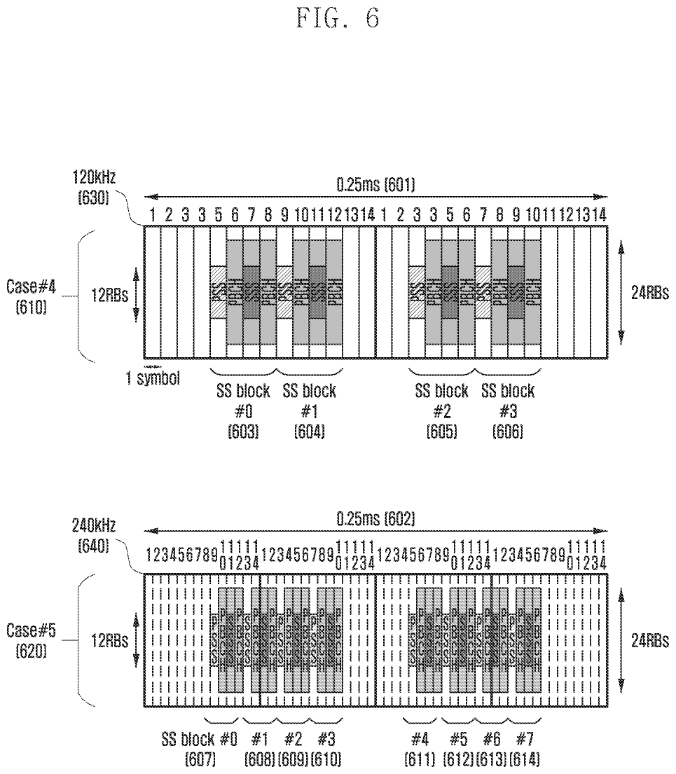

FIG. 6 is a diagram illustrating transmission cases of a synchronization signal block in a frequency band of 6 GHz or higher considered in the wireless communication system, to which the disclosure is applied according to an embodiment of the disclosure.

In the 5G communication system, in a frequency band of 6 GHz or higher, a subcarrier spacing 630 of 120 kHz as shown in case #4 610 and a subcarrier spacing 640 of 240 kHz as shown in case #5 620 may be used for synchronization signal block transmission.

In case #4 610 with the subcarrier spacing 630 of 120 kHz, up to 4 synchronization signal blocks may be transmitted in 0.25 ms of time 601 (or corresponding to a length of 2 slots when 1 slot includes 14 OFDM symbols). In an example of FIG. 6, a case where synchronization signal block #0 603, synchronization signal block #1 604, synchronization signal block #2 605, and synchronization signal block #3 606 are transmitted in 0.25 ms of time (i.e., two slots) is illustrated. Synchronization signal block #0 603 and synchronization signal block #1 604 may be respectively mapped to 4 consecutive symbols starting from a fifth OFDM symbol and to 4 consecutive symbols starting from a ninth OFDM symbol of a first slot, and synchronization signal block #2 605 and synchronization signal block #3 606 may be respectively mapped to 4 consecutive symbols starting from a third OFDM symbol and to 4 consecutive symbols starting from a seventh OFDM symbol of a second slot.

As described in the embodiment above, different analog beams may be used for synchronization signal block #0 603, synchronization signal block #1 604, synchronization signal block #2 605, and synchronization signal block #3 606, respectively. In addition, the same analog beam may be used for all 4 OFDM symbols in which respective synchronization signal block are transmitted, and in OFDM symbols to which no synchronization signal block is mapped, beams to be used may be freely determined at the discretion of a base station.

In case #5 620 with the subcarrier spacing 640 of 240 kHz, up to 8 synchronization signal blocks may be transmitted in 0.25 ms of time 602 (or corresponding to a length of 4 slots when 1 slot includes 14 OFDM symbols). In an example of FIG. 6, a case where synchronization signal block #0 607, synchronization signal block #1 608, synchronization signal block #2 609, synchronization signal block #3 610, synchronization signal block #4 611, synchronization signal block #5 612, synchronization signal block #6 613, and synchronization signal block #7 614 are transmitted in 0.25 ms of time (i.e., 4 slots) is illustrated.

Synchronization signal block #0 607 and synchronization signal block #1 608 may be respectively mapped to 4 consecutive symbols starting from a ninth OFDM symbol and to 4 consecutive symbols starting from a 13th OFDM symbol of a first slot, synchronization signal block #2 609 and synchronization signal block #3 610 may be respectively mapped to 4 consecutive symbols starting from a third OFDM symbol and to 4 consecutive symbols starting from a seventh OFDM symbol of a second slot, synchronization signal block #4 611, synchronization signal block #5 612, and synchronization signal block #6 613 may be respectively mapped to 4 consecutive symbols starting from a fifth OFDM symbol, to 4 consecutive symbols starting from a ninth OFDM symbol, and to 4 consecutive symbols starting from a 13th OFDM symbol of a third slot, and synchronization signal block #7 614 may be mapped to 4 consecutive symbols starting from a third OFDM symbol of a fourth slot.

As described in the embodiment above, different analog beams may be applied to synchronization signal block #0 607, synchronization signal block #1 608, synchronization signal block #2 609, synchronization signal block #3 610, synchronization signal block #4 611, synchronization signal block #5 612, synchronization signal block #6 613, and synchronization signal block #7 614, respectively. In addition, the same analog beam may be used for all 4 OFDM symbols in which respective synchronization signal block are transmitted, and in OFDM symbols to which no synchronization signal block is mapped, beams to be used may be freely determined at the discretion of a base station.

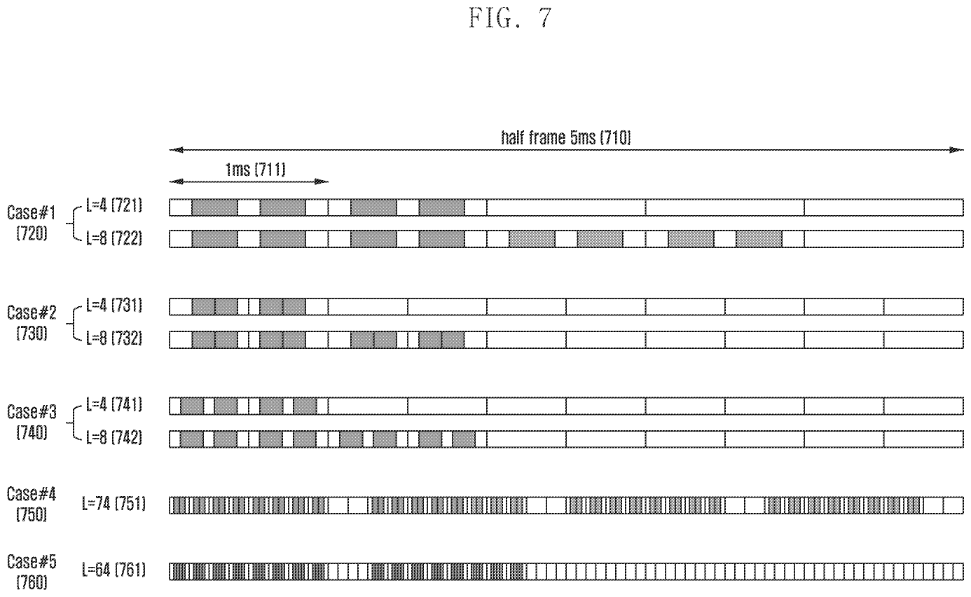

FIG. 7 is a diagram illustrating transmission cases of a synchronization signal block according to a subcarrier spacing within 5 ms in the wireless communication system, to which the disclosure is applied according to an embodiment of the disclosure.

Referring to FIG. 7, synchronization signal blocks are transmitted periodically, for example, in units of time intervals 710 of 5 ms (corresponding to 5 subframes or a half frame).

In a frequency band of 3 GHz or lower, up to 4 synchronization signal blocks may be transmitted within 5 ms of time 710. In a frequency band higher than 3 GHz and equal to or lower than 6 GHz, up to 8 synchronization signal blocks may be transmitted. In a frequency band higher than 6 GHz, up to 64 synchronization signal blocks may be transmitted. As described above, subcarrier spacings of 15 kHz and 30 kHz may be used at a frequency of 6 GHz or lower.

According to FIG. 7, in case #1 720 including one slot with the subcarrier spacing of 15 kHz, synchronization signal blocks may be mapped to a first slot and a second slot so that up to 4 synchronization signal blocks 721 may be transmitted in a frequency band of 3 GHz or lower, and synchronization signal blocks may be mapped to first, second, third, and fourth slots so that up to 8 synchronization signal blocks 722 may be transmitted in a frequency band higher than 3 GHz and equal to or lower than 6 GHz. In case #2 730 or case #3 740 including two slots with the subcarrier spacing of 30 kHz in FIG. 7, synchronization signal blocks may be mapped starting from a first slot so that up to 4 synchronization signal blocks 731 and 741 may be transmitted in a frequency band of 3 GHz or lower, and synchronization signal blocks may be mapped starting from first and third slots so that up to 8 synchronization signal blocks 732 and 742 may be transmitted in a frequency band higher than 3 GHz and equal to or lower than 6 GHz.

The subcarrier spacings of 120 kHz and 240 kHz may be used at a frequency higher than 6 GHz. In an example of FIG. 7, in case #4 750 including two slots with the subcarrier spacing of 120 kHz, synchronization signal blocks may be mapped starting from first, third, fifth, seventh, 11th, 13th, 15th, 17th, 21st, 23rd, 25th, 27th, 31st, 33rd, 35th, and 37th slots so that up to 64 synchronization signal blocks 751 may be transmitted in a frequency band higher than 6 GHz. In case #5 760 including 4 slots with the subcarrier spacing of 240 kHz, synchronization signal blocks may be mapped starting from first, fifth, ninth, 13th, 21st, 25th, 29th, and 33rd slots so that up to 64 synchronization signal blocks 761 may be transmitted in a frequency band higher than 6 GHz.

In general, the terminal may establish a radio link to a network via random access, based on system information and synchronization with the network acquired during a cell search. A contention-based or contention-free scheme may be used for random access. When the terminal performs cell selection and reselection during an initial cell access operation, for example, for the purpose of moving from an RRC_IDLE (RRC idle) state to an RRC_CONNECTED (RRC connected) state, the contention-based random-access scheme may be used. Contention-free random access may be used to re-establish uplink synchronization in a case of downlink data arrival, handover, or positioning. Table 3 below illustrates conditions (events) for triggering of random access in the 5G system.

TABLE 3
Initial access from RRC_IDLE;
RRC Connection Re-establishment procedure;
DL or UL data arrival during RRC_CONNECTED when UL synchronization
status is “non-synchronized”;
UL data arrival during RRC_CONNECTED when there are no physical uplink
control channel (PUCCH) resources for SR available;
SR failure;
Request by RRC upon synchronous reconfiguration (e.g., handover);
RRC Connection Resume procedure from RRC_INACTIVE;
To establish time alignment for a secondary TAG;
Request for Other SI;
Beam failure recovery;
Consistent UL LBT failure on special cell (SpCell).

Hereinafter, a description will be provided for a measurement time configuration method for radio resource management (RIRM) based on a synchronization signal block (SS block or SSB) of the 5G wireless communication system.

The terminal may be configured with MeasObjectNR of MeasObjectToAddModList for SSB-based intra/inter-frequency measurements and CSI-RS-based intra/inter-frequency measurements via higher-layer signaling. For example, MeasObjectNR is configured as shown in Table 4 below.

TABLE 4

| | |
|---|---|
| MeasObjectNR ::= | SEQUENCE { |

| | |
|---|---|
| ssbFrequency ARFCN-ValueNR | OPTIONAL, - |

- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS- |
| ResourcesToAverage) | OPTIONAL, -- Need R |
| quantityConfigIndex | INTEGER (1..maxNrofQuantityConfig), |
| offsetMO | Q-OffsetRangeList, |
| cellsToRemoveList | PCI-List |

OPTIONAL, -- Need N

| | |
|---|---|
| cellsToAddModList | OPTIONAL, -- |

Need N

| | |
|---|---|
| blackCellsToRemoveList | PCI-RangeIndexList |

OPTIONAL, -- Need N

| | |
|---|---|
| blackCellsToAddModList | SEQUENCE (SIZE (1..maxNrofPCI-Ranges)) |

OF PCI-RangeElement OPTIONAL, -- Need N

| | |
|---|---|
| whiteCellsToRemoveList | PCI-RangeIndexList |

OPTIONAL, -- Need N

| | |
|---|---|
| whiteCellsToAddModList | SEQUENCE (SIZE (1..maxNrofPCI-Ranges)) |

```
OF PCI-RangeElement OPTIONAL, -- Need N
  ...,
  [[
```

| | |
|---|---|
| freqBandIndicatorNR | OPTIONAL, -- |

Need R

| | |
|---|---|
| measCycleSCell | ENUMERATED {sf160, sf256, sf320, sf512, |

```
sf640, sf1024, sf1280} OPTIONAL -- Need R
  ]],
  [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

OPTIONAL -- Need M
]]
}

ssbFrequency: A frequency of a synchronization signal related to MeasObjectNR may be configured.
ssbSubcarrierSpacing: A subcarrier spacing of SSB may be configured. Only 15 kHz or 30 kHz may be applied for FR1, and only 120 kHz or 240 kHz may be applied for FR2.
smtc1: smtc1 may indicate an SS/PBCH block measurement timing configuration, a primary measurement timing configuration may be configured, and a timing offset and duration for SSB may be configured.
smtc2: A secondary measurement timing configuration for SSB related to MeasObjectNR having a PCI listed in pci-List may be configured.

In addition, SMTC may be configured via other higher-layer signaling. For example, SMTC is configured for the terminal via reconfigurationWithSync for NR primary secondary cell (PSCell) change and NR primary cell (PCell) change or SIB2 for intra-frequency, inter-frequency, and inter-RAT cell reselection, and SMTC may also configured for the terminal via SCellConfig for adding an NR secondary cell (SCell).

The terminal may configure a first SS/PBCH block measurement timing configuration (SMTC) according to periodictiyAndOffset (providing periodicity and offset) via smtc1 configured via higher-layer signaling for SSB measurement. In an embodiment, a first subframe of each SMTC occasion may start from a subframe of an SpCell and a system frame number (SFN) which satisfy conditions in Table 5 below.

TABLE 5

SFN mod T = (FLOOR (Offset/10));
if the Periodicity is larger than sf5:
subframe = Offset mod 10;
else:
subframe = Offset or (Offset +5);
with T = CEIL(Periodicity/10).

If smtc2 is configured, for cells indicated by pci-List values of smtc2 in the same MeasObjectNR, the terminal may configure an additional SMTC according to the periodicity of configured smtc2 and the offset and duration of smtc1. In addition, for the same frequency (e.g., a frequency for intra frequency cell reselection) or different frequencies (e.g., frequencies for inter frequency cell reselection), the terminal may be configured with smtc and measure an SSB, via smtc3list for smtc2-LP (with long periodicity) and integrated access and backhaul-mobile termination (IAB-MT). In an embodiment, the terminal may not consider an SSB transmitted in a subframe other than an SMTC occasion for SSB-based RRM measurement in configured ssbFrequency.

Subsequently, a demodulation reference signal (DMRS) that is one of reference signals in the 5G system will be described in detail.

A DMRS may include multiple DMRS ports, and each of the ports may maintain orthogonality by using code division multiplexing (CDM) or frequency division multiplexing (FDM) so as to prevent interference with each other. However, the term for DMRS may be expressed in other terms depending on a user's intention and the purpose of using a reference signal. The term DMRS merely provides a specific example to easily describe the technical content of the disclosure and to help understanding of the disclosure, and is not intended to limit the scope of the disclosure. In other words, it is apparent to those skilled in the art belonging to the disclosure, that the disclosure may be implemented for any reference signal based on the technical idea of the disclosure.

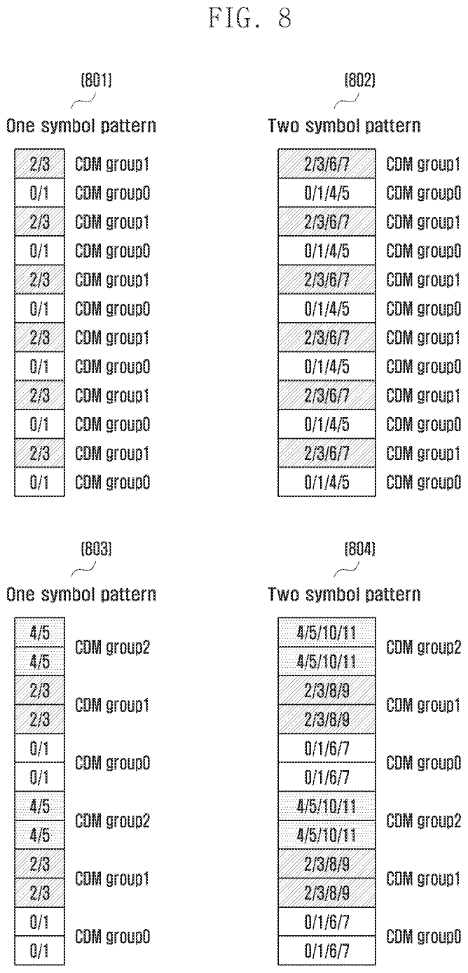

FIG. 8 is a diagram illustrating DMRS patterns (type1 and type2) used for communication between a base station and a terminal in the 5G system according to an embodiment of the disclosure. Two DMRS patterns may be supported in the 5G system. FIG. 8 illustrates two DMRS patterns.

Referring to FIG. 8, patterns 801 and 802 correspond to DMRS type1, where pattern 801 indicates a 1-symbol pattern and pattern 802 indicates a 2-symbol pattern. DMRS type 1 of patterns 801 and 802 is a DMRS pattern with a comb 2 structure and may include two CDM groups, and different CDM groups may be FDMed.

In the 1-symbol pattern 801, CDM on frequency may be applied to the same CDM group so that 2 DMRS ports may be distinguished, and therefore a total of 4 orthogonal DMRS ports may be configured. The 1-symbol pattern 801 may include a DMRS port ID mapped to each CDM group (e.g., a DMRS port ID for downlink may be indicated by an illustrated number+1000). In the 2-symbol pattern 802, CDM on time/frequency may be applied to the same CDM group so that 4 DMRS ports may be distinguished, and therefore a total of 8 orthogonal DMRS ports may be configured. The 2-symbol pattern 802 may include a DMRS port ID mapped to each CDM group (e.g., a DMRS port ID for downlink may be indicated by an illustrated number+1000).

DMRS type2 illustrated in patterns 803 and 804 is a DMRS pattern with a structure in which frequency domain orthogonal cover codes (FD-OCCs) are applied to a subcarrier adjacent on frequency, and may include three CDM groups, and different CDM groups may be FDMed.

In the 1-symbol pattern 803, CDM on frequency may be applied to the same CDM group so that 2 DMRS ports may be distinguished, and therefore a total of 6 orthogonal DMRS ports may be configured. The 1-symbol pattern 803 may include a DMRS port ID mapped to each CDM group (e.g., a DMRS port ID for downlink may be indicated by an illustrated number+1000). In the 2-symbol pattern 704, CDM on time/frequency may be applied to the same CDM group so that 4 DMRS ports may be distinguished, and therefore a total of 12 orthogonal DMRS ports may be configured. The 2-symbol pattern 804 may include a DMRS port ID mapped to each CDM group (e.g., a DMRS port ID for downlink may be indicated by an illustrated number+1000).

As described above, in the NR system, two different DMRS patterns (e.g., the DMRS patterns 801 and 802 or the DMRS patterns 803 and 804) may be configured, and whether each DMRS pattern is a one-symbol pattern 801 or 803 or is an adjacent two-symbol pattern 802 or 804 may also be configured. In addition, in the NR system, not only a DMRS port number may be scheduled, but also the number of CDM groups scheduled together for PDSCH rate matching may be configured and signaled. In addition, for cyclic prefix-based orthogonal frequency division multiplexing (CP-OFDM), both the aforementioned two DMRS patterns may be supported in DL and UL, and for discrete Fourier transform spread OFDM (DFT-S-OFDM), only DMRS type1 among the aforementioned DMRS patterns may be supported in UL.

In addition, an additional DMRS may be supported to be configurable. A front-loaded DMRS may refer to a first DMRS transmitted and received in a front-most symbol in the time domain from among DMRSs, and an additional DMRS may refer to a DMRS transmitted and received in a symbol subsequent to the front-loaded DMRS in the time domain. In the NR system, the number of additional DMRSs may be configured to be a minimum of 0 to a maximum of 3. In addition, when an additional DMRS is configured, the same pattern as the front-loaded DMRS may be assumed. In an embodiment, when information on whether the described DMRS pattern type for the front-loaded DMRS is type1 or type2, information on whether the DMRS pattern is a one-symbol pattern or is an adjacent two-symbol pattern, and information on a DMRS port and the number of CDM groups used are indicated, in a case where an additional DMRS is further configured, it may be assumed that the additional DMRS is configured with the same DMRS information as that for the front-loaded DMRS.

In an embodiment, the downlink DMRS configuration described above may be configured via RRC signaling as shown in Table 6 below.

TABLE 6

| DMRS-DownlinkConfig ::= | SEQUENCE { | |
|---|---|---|
| dmrs-Type | ENUMERATED {type2} | OPTIONAL, -- Need S |

dmrs-AdditionalPosition ENUMERATED {pos0, pos1, pos3} OPTIONAL, -
- Need S

| | | |
|---|---|---|
| maxLength | ENUMERATED {len2} | OPTIONAL, -- Need S |
| scramblingID0 | INTEGER (0..65535) | OPTIONAL, -- Need S |
| scramblingID1 | INTEGER (0..65535) | OPTIONAL, -- Need S |

| | |
|---|---|
| phaseTrackingRS | SetupRelease {PTRS-DownlinkConfig} OPTIONAL, -- |

Need M
...
}

Here, dmrs-Type may configure a DMRS type, dmrs-AdditionalPosition may configure additional DMRS OFDM symbols, maxLength may configure a 1-symbol DMRS pane or a 2-symbol DMRS pattern, scramblingID0 and scramblingID1 may configure scrambling IDs, and phaseTrackingRS may configure a phase tracking reference signal (PTRS).

In addition, the uplink DMRS configuration described above may be configured via RRC signaling as shown in Table 7 below.

TABLE 7

| DMRS-UplinkConfig ::= | SEQUENCE { | |
|---|---|---|
| dmrs-Type | ENUMERATED {type2} | OPTIONAL, -- Need S |
| dmrs-AdditionalPosition | ENUMERATED {pos0, pos1, pos3} | OPTIONAL, |

-- Need R

| | | |
|---|---|---|
| phaseTrackingRS | SetupRelease { PTRS-UplinkConfig } | OPTIONAL, - |

- Need M

| maxLength | ENUMERATED {len2} | OPTIONAL, -- Need S |
|---|---|---|
| transformPrecodingDisabled | SEQUENCE { | |
| scramblingID0 | INTEGER (0..65535) | OPTIONAL, -- Need S |
| scramblingID1 | INTEGER (0..65535) | OPTIONAL, -- Need S |

| | |
|---|---|
| ... | OPTIONAL, -- Need R |

}

| transformPrecodingEnabled | SEQUENCE { | |
|---|---|---|
| nPUSCH-Identity | INTEGER (0..1007) | OPTIONAL, -- Need S |
| sequenceGroupHopping | ENUMERATED {disabled} | OPTIONAL, -- |
| Need S | | |
| sequenceHopping | ENUMERATED {enabled} | OPTIONAL, -- Need |

S
...

| | |
|---|---|
| } | OPTIONAL, -- Need R |

...
}

Here, dmrs-Type may configure a DMRS type, dmrs-AdditionalPosition may configure additional DMRS OFDM symbols, phaseTrackingRS may configure a PTRS, and maxLength may configure a 1-symbol DMRS pattern or a 2-symbol DMRS pattern. scramblingID0 and scramblingID1 may configure scrambling ID0s, nPUSCH-Identity may configure a cell ID for DFT-s-OFDM, sequenceGroupHopping may disable sequence group hopping, and sequenceHopping may enable sequence hopping.

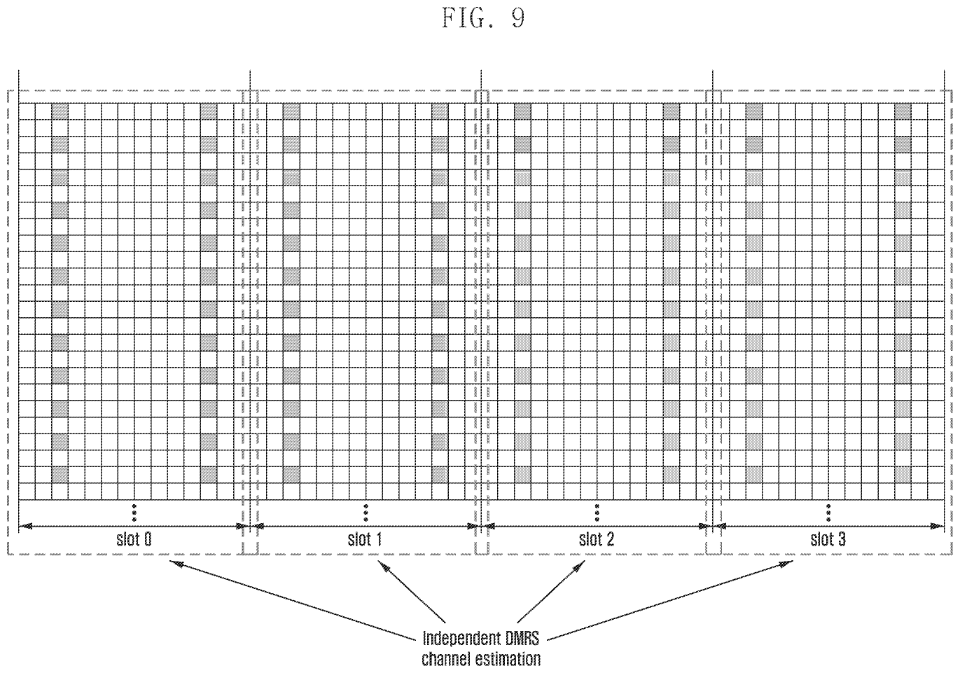

FIG. 9 is a diagram illustrating an example of channel estimation using a DMRS received on one PUSCH in a time band of the 5G system according to an embodiment of the disclosure.

Referring to FIG. 9, when performing channel estimation for data decoding using a DMRS, the channel estimation may be performed within a precoding resource block group (PRG), which is a corresponding bundling unit, by using physical resource block (PRB) bundling linked to a system band in a frequency band. In addition, channel estimation is performed by assuming that, in the time unit, only DMRSs received on one PUSCH have the same precoding.

Hereinafter, a description will be provided for a time domain resource allocation (TDRA) method for a data channel in the 5G communication system. The base station may configure, for the terminal via higher-layer signaling (e.g., RRC signaling), a table for time domain resource allocation information on a downlink data channel (PDSCH) and an uplink data channel (PUSCH).

The base station may configure a table including up to maxNrofDL-Allocations=17 entries for a PDSCH, and may configure a table including up to maxNrofUL-Allocations=17 entries for a PUSCH. The time domain resource allocation information includes, for example, at least one of PDCCH-to-PDSCH slot timing (denoted as KO, and corresponding to a time interval in units of slots between a time point at which a PDCCH is received and a time point at which a PDSCH scheduled by the received PDCCH is transmitted), PDCCH-to-PUSCH slot timing (denoted as K2, and corresponding to a time interval in units of slots between a time point at which a PDCCH is received and a time point at which a PUSCH scheduled by the received PDCCH is transmitted), information on a position and a length of a start symbol in which the PDSCH or PUSCH is scheduled within a slot, a mapping type of the PDSCH or PUSCH, or the like.

In an embodiment, the time domain resource allocation information for the PDSCH may be configured for the terminal via RRC signaling as shown in Table 8 below.

TABLE 8
PDSCH-TimeDomainResourceAllocationList information element

| | |
|---|---|
| PDSCH-TimeDomainResourceAllocationList | ::= SEQUENCE |

(SIZE(1..maxNrofDL-Allocations)) OF PDSCH-TimeDomainResourceAllocation

| PDSCH-TimeDomainResourceAllocation ::= | | SEQUENCE { |
|---|---|---|
| k0 | INTEGER(0..32) | OPTIONAL, -- Need S |

| | |
|---|---|
| mappingType | ENUMERATED {typeA, typeB}, |
| startSymbolAndLength | INTEGER (0..127) |
| repetitionNumber | ENUMERATED {n2, n3, n4, n5, n6, n7, n8, n16} |

OPTIONAL, -- Cond Formats1-0and1-1
}

Here, k0 may indicate PDCCH-to-PDSCH timing (i.e., a slot offset between DCI and the scheduled PDSCH) in slot units, mappingType may indicate a PDSCH mapping type, startSymbolAndLength may indicate a start symbol and a length of the PDSCH, and repetitionNumber may indicate the number of PDSCH transmission occasions according to a slot-based repetition scheme.

In an embodiment, the time domain resource allocation information for the PUSCH may be configured for the terminal via RRC signaling as shown in Table 9 below.

TABLE 9
PUSCH-TimeDomainResourceAllocation information element

| | |
|---|---|
| PUSCH-TimeDomainResourceAllocationList ::= | SEQUENCE |

(SIZE(1..maxNrofUL-Allocations)) OF PUSCH-TimeDomainResourceAllocation

| PUSCH-TimeDomainResourceAllocation ::= | | SEQUENCE { |
|---|---|---|
| k2 | INTEGER(0..32) | OPTIONAL, -- Need S |

| | |
|---|---|
| mappingType | ENUMERATED {typeA, typeB}, |
| startSymbolAndLength | INTEGER (0..127) |

}
PUSCH-Allocation-r16 ::= SEQUENCE {

| | | |
|---|---|---|
| mappingType-r16 | ENUMERATED {typeA, typeB} | OPTIONAL, -- |

Cond NotFormat01-02-Or-TypeA

| | |
|---|---|
| startSymbolAndLength-r16 INTEGER (0..127) | OPTIONAL, -- Cond |

NotFormat01-02-Or-TypeA

| | | |
|---|---|---|
| startSymbol-r16 | INTEGER (0..13) | OPTIONAL, -- Cond RepTypeB |
| length-r16 | INTEGER (1..14) | OPTIONAL, -- Cond RepTypeB |

```
  numberOfRepetitions-r16 ENUMERATED {n1, n2, n3, n4, n7, n8, n12, n16}
OPTIONAL, -- Cond Format01-02
  ...
}
```

Here, k2 may indicate PDCCH-to-PUSCH timing (i.e., a slot offset between DCI and scheduled PUSCH) in units of slots, mappingType may indicate a PUSCH mapping type, startSymbolAndLength or StartSymbol and length may indicate a start symbol and a length of the PUS CH, and numberOfRepetitions may indicate the number of repetitions applied to PUSCH transmission.

The base station may indicate, to the terminal, at least one of entries in the table for the time domain resource allocation information via L1 signaling (e.g., DCI) (e.g., an entry may be indicated via a “time domain resource allocation” field in the DCI). The terminal may acquire the time domain resource allocation information for the PDSCH or PUSCH, based on the DCI received from the base station.

Hereinafter, a description will be provided for a method of reducing SSB density via dynamic signaling to save base station energy in the 5G system.

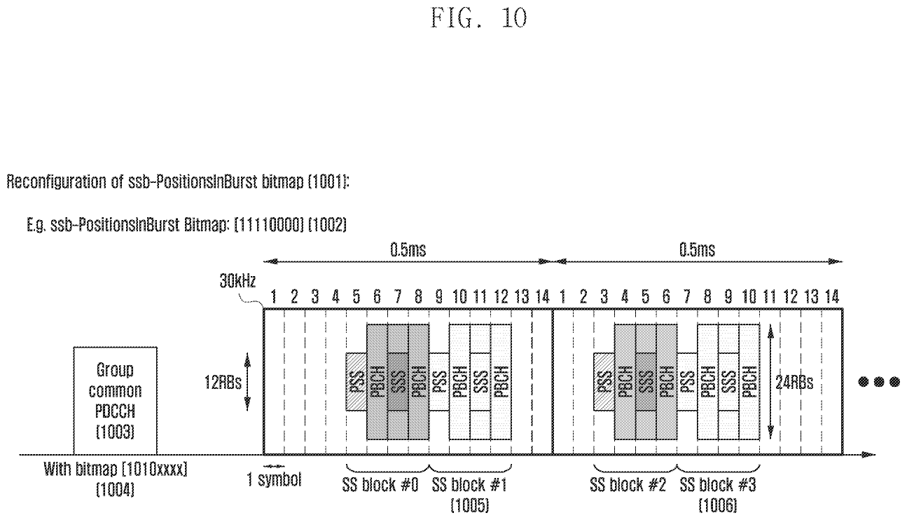

FIG. 10 is a diagram illustrating an example of a method of reconfiguring SSB transmission via dynamic signaling in the wireless communication system, to which the disclosure is applied according to an embodiment of the disclosure.

Referring to FIG. 10, a terminal may be configured with ssb-PositionsInBurst=“11110000” 1002 from a base station via higher-layer signaling (SIB1 or ServingCellConfigCommon). Up to two synchronization signal blocks at a subcarrier spacing of 30 kHz may be transmitted within 0.5 ms (or corresponding to a length of 1 slot when 1 slot includes 14 OFDM symbols), and accordingly, the terminal may receive 4 synchronization signal blocks (SSBs) within 1 ms (or corresponding to a length of 2 slots when 1 slot includes 14 OFDM symbols). In this case, in order to reduce SSB transmission density to save energy, the base station may reconfigure SSB transmission configuration information by broadcasting bitmap “1010xxxx” 1004 via group/cell common DCI 1003 having a network energy saving-radio network temporary identifier (nwes-RNTI) (or es-RNTI). In this case, the base station may cancel transmission of SS block #1 1005 and SS block #3 1006, based on the bitmap 1004 configured via the group/cell common DCI. FIG. 10 provides a method 1001 of reconfiguring SSB transmission via bitmap-based group/cell common DCI.

In addition, via the group/cell common DCI, the base station may reconfigure ssb-periodicity configured via higher-layer signaling. In addition, by additionally configuring timer information for indication of a time point to apply the group/cell common DCI, SSB transmission may be performed according to SSB transmission information reconfigured via the group/cell common DCI during the configured timer. Then, when the timer expires, the base station may operate according to the SSB transmission information configured via existing higher-layer signaling. That is, a configuration may be changed from a normal mode to an energy saving mode via the timer, and as a result, the SSB configuration information may be reconfigured. As another method, the base station may configure, as duration and offset information for the terminal, a period and a time point to apply the SSB configuration information reconfigured via the group/cell common DCI. In this case, the terminal may not monitor the SSB according to the reconfigured SSB configuration information for the duration from a point in time of receiving the group/cell common DCI and then applying the offset.

Hereinafter, a description will be provided for a method of BWP or BW adaptation via dynamic signaling for energy reduction of a base station in the 5G system.

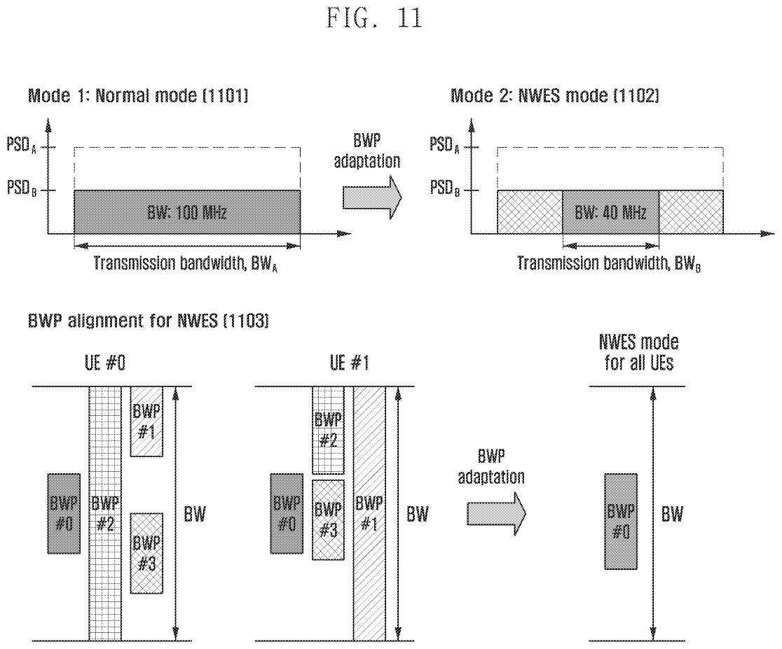

FIG. 11 is a diagram illustrating a method of reconfiguring a BWP and a BW via dynamic signaling according to an embodiment of the disclosure.

Referring to FIG. 11, a terminal may operate using a BWP or BW activated via higher-layer signaling and L1 signaling from a base station, in mode 1101. For example, the terminal operates via a full BW of 100 MHz with fixed power PSD_{B}. In this case, for energy saving, the base station may adjust the BW and BWP to activate, for the terminal, a narrower BW of 40 MHz with the same power PSD_{B}, in mode 1102. In this case, the adjusting of the BW or BWP for energy saving by the base station may be performed to equally adjust the UE-specifically configured BWP and BW via group common DCI and cell-specific DCI, in mode 1103. For example, UE #0 and UE #1 have different BWP configurations and positions. In this case, in order for the base station to save energy by reducing BWs used, BWs and BWPs of all terminals may be configured equally to one. In this case, one or more BWPs or BWs in the operation for energy saving may be configured, which may be used to configure a UE group-specific BWP.

Hereinafter, a description will be provided for a DRX alignment method via dynamic signaling to save base station energy in the 5G system.

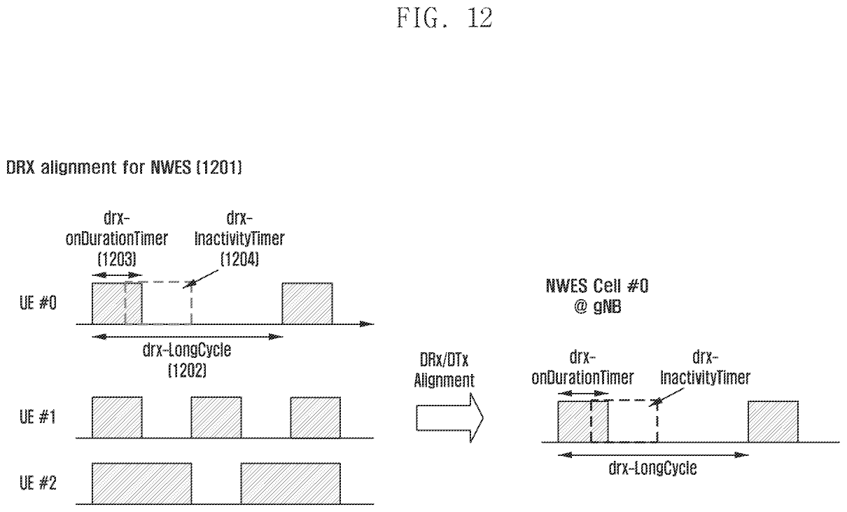

FIG. 12 is a diagram illustrating a method of reconfiguring DRX via dynamic signaling according to an embodiment of the disclosure.

Referring to FIG. 12, a base station may UE-specifically configure DRX via higher-layer signaling. For example, different drx-LongCycle 1202, drx-ShortCycle, drx-onDurationTimer 1203, and drx-InactivityTimer 1204 is configured for each terminal. Then, for energy saving, the base station may configure 1201 the UE-specific DRX configuration to be UE group-specific or cell-specific via L1 signaling. Based on this, the base station may achieve, for energy saving, the same effect as that of a terminal saving power via DRX.

Hereinafter, a description will be provided for a discontinuous transmission (DTx) operation for reducing energy consumption of a base station in the 5G system.

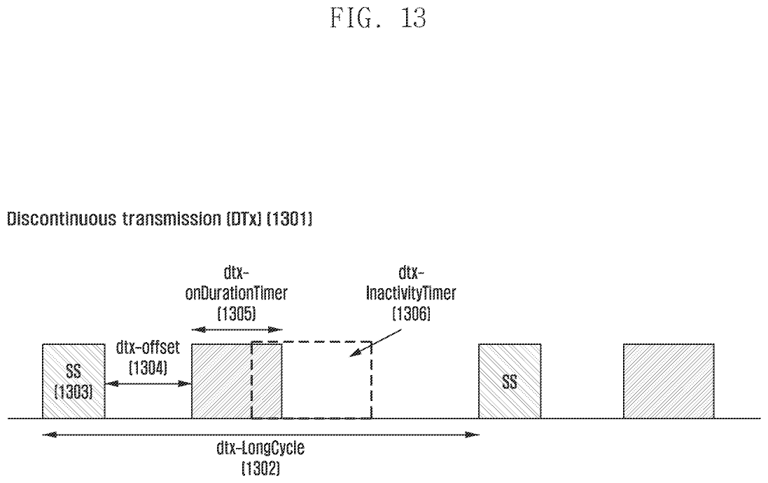

FIG. 13 is a diagram illustrating a DTx method for base station energy saving according to an embodiment of the disclosure.

Referring to FIG. 13, a base station may configure discontinuous transmission (DTx) 1301 for energy saving via higher-layer signaling (new system information block (SIB) for DTx or RRC signaling) and L1 signaling (DCI). In this case, for a DTx operation, the base station may configure dtx-onDurationTimer 1305 for transmitting a PDCCH for DL SCH scheduling or a reference signal for RRM measurement, beam management, pathloss, and the like, dtx-InactivityTimer 1306 for receiving a PDSCH after reception of the PDCCH for DL SCH scheduling, synchronization signal (SS) 1303 configuration information for synchronization before dtx-onDurationTimer, dtx-offset 1304 for configuring an offset between dtx-onDurationTimer after SS, and dtx-(Long)Cycle 1302 for DTx to operate periodically based on the configuration information. In this case, dtx-cycle may include a long cycle and a short cycle, and a plurality of dtx-cycle may be configured. During the DTx operation, the base station may consider a transmission end to be off (or inactive) and therefore, the base station may not transmit DL CCH, SCH, and DL RS. That is, during the DTx operation, the base station may transmit downlink signals and channels (PDCCH, PDSCH, RS, and the like) only during SS, dtx-onDurationTimer, and dtx-InactivityTimer. In this case, SS-gapbetweenBurst or the number of SS bursts may be additionally configured as additional information on the configured SS.

Hereinafter, a description will be provided for a method of activating a base station via a gNB wake-up signal (WUS) during a deactivation mode of the base station in order to reduce energy consumption of the base station in the 5G system.

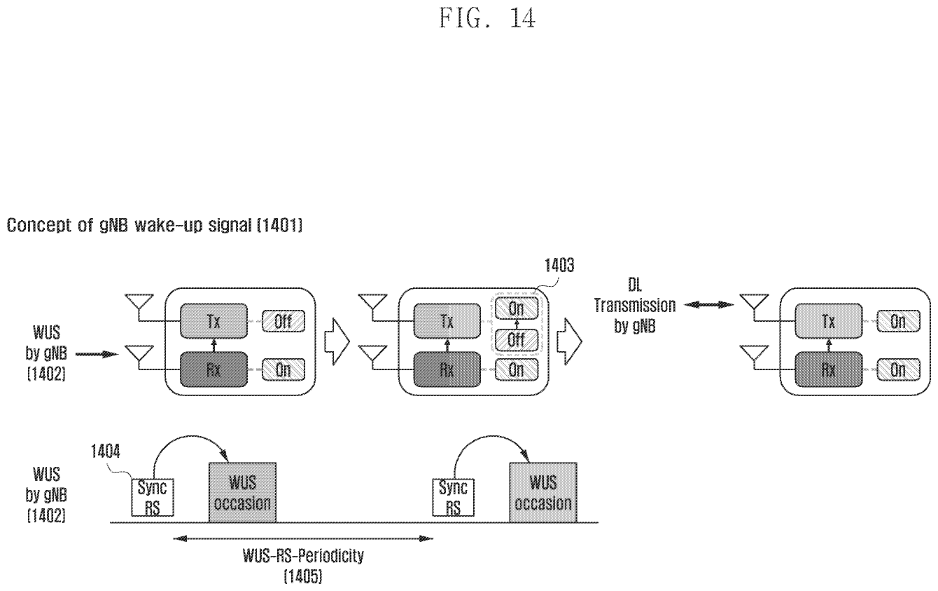

FIG. 14 is a diagram for illustrating a base station operation according to a gNB wake-up signal according to an embodiment of the disclosure.

Referring to FIG. 14, operation 1401 of a base station when receiving a gNB wake-up signal is as follows. The base station may maintain a transmitter in an off (or inactive) state while the base station is in an inactive state (or sleep mode) for energy saving. Then, the base station may receive a gNB wake-up signal 1402 from a terminal to activate the base station from the sleep mode. Then, the base station may change the transmitter (Tx) to be an on (or active) state, in operation 1403. Then, the base station may perform downlink transmission to the terminal. In this case, the base station may perform synchronization after Tx on, and perform control channel and data channel transmission. In addition, in this case, various uplink signals, such as a PRACH, a scheduling request (SR PUCCH), a PUCCH including acknowledgement (ACK), and the like, may be considered as the gNB WUS. Via the method above, the base station may perform energy saving, and at the same time, the terminal may improve latency.

In this case, the base station may configure a WUS occasion for receiving a gNB WUS, and a Sync RS for synchronization before the terminal transmits a gNB WUS. In this case, an SSB, a tracking RS (TRS), a light SSB (PSS and SSS), consecutive SSBs, or a new RS (e.g., continuous PSS and SSS) may be considered as the Sync RS, and a PRACH, a PUCCH with SR, or a sequence-based signal may be considered as the WUS. A Sync RS 1404 for the terminal to activate a deactivation mode for energy saving of the base station, and a WUS occasion for receiving a WUS may be repeatedly configured in a WUS-RS periodicity 1405. In the case of the example in FIG. 14, 1-to-1 mapping of the Sync RS and the WUS occasion is described as an embodiment, but the disclosed is not limited thereto, and the Sync RS and the WUS occasion may be N-to-1 mapped, 1-to-N mapped, or N-to-M mapped.

Hereinafter, a description will be provided for a method of dynamically turning on/off spatial domain elements (i.e., antenna, PA or TxRUs) of a base station to save base station energy in the 5G system.

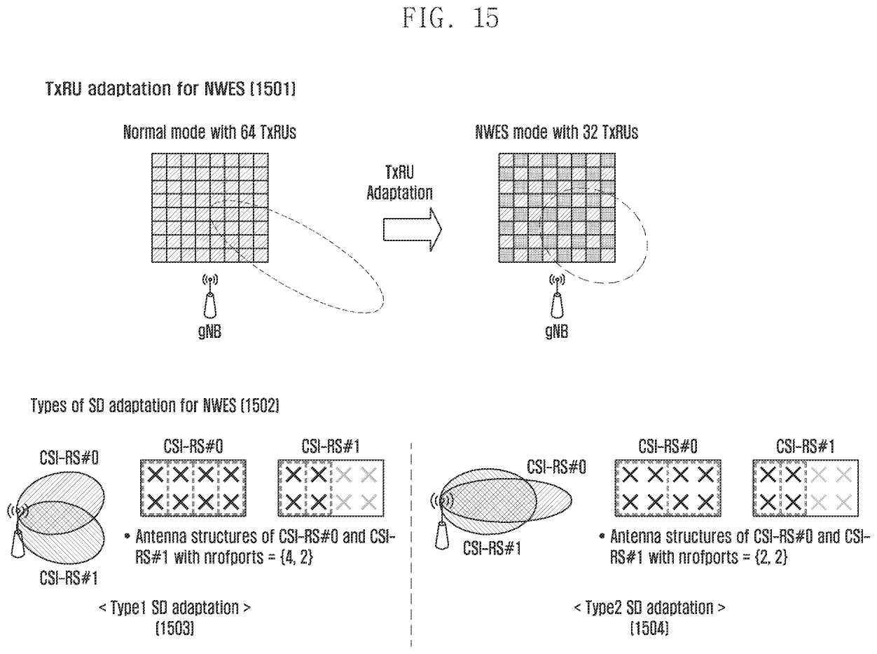

FIG. 15 is a diagram illustrating an example of a spatial domain (SD) adaptation method of a base station for energy saving according to an embodiment of the disclosure.

Referring to FIG. 15, a base station may adjust a Tx antenna port per radio unit (RU) for energy saving (network energy savings (NWES)). Since energy consumed in a PA of the base station accounts for most of energy consumption of the base station, the base station may turn off 1501 a Tx antenna to save energy. In this case, in order to determine whether the Tx antenna may be turned off, the base station may transmit a signal by adjusting the number of activated Tx antennas for each UE group or UE by referring to RSRP, CQI, RSRQ, and the like, of a terminal. In this case, the base station may configure, for a terminal, beam information, reference signal information (a CSI resource, a CSI-RS resource/resource set, an SSB set or a CSI report), and the like, according to the antenna on/off via higher-layer signaling (RRC) and DCI signaling. In addition, different antenna information may be configured for each BWP, and thus the antenna information may be reconfigured according to a BWP change. In addition, the base station may receive CSI feedback from the terminal to determine whether SD adaptation is possible, and determine SD adaptation, and to this end, the base station may receive multiple feedback via antenna structure hypotheses of various antenna patterns for SD adaptation.

More specifically, the base station may apply 1502 two types of SD adaptation for energy saving. For example, the base station applies Type 1 SD adaptation 1503 to adapt the number of antenna ports while maintaining the number of physical antenna elements per antenna port (i.e., a logical port or a port may be interchangeably used). In this case, RF characteristics (e.g., tx power and beam) per port of the base station may be the same. Therefore, the terminal may perform measurement by combining CSI-RSs with the same port index during CSI measurement (e.g., L1-RSRP, L3-RSRP, and the like) (even if energy saving is applied and the number of antenna ports is changed).

As another method, the base station may maintain the same number of antenna ports (i.e., logical ports), and apply Type 2 SD adaptation 1504 to turn on/off the physical antenna element per port. In this case, the RF characteristics per port may vary, and when energy saving is applied during CSI measurement and RF characteristics of an antenna port are changed, the terminal needs to distinguish CSI-RSs of the same port in a section to which energy saving is applied and a section to which energy saving is not applied, and perform measurement separately. The base station may save energy via the two representative types of SD adaptation methods or various methods.

Hereinafter, a description will be provided for a method in which, for energy saving, a base station determines SD adaptation based on CSI feedback for each terminal. The base station may obtain CSI feedback to determine an appropriate antenna pattern for SD adaptation for each terminal by using one of or a combination of the following methods.

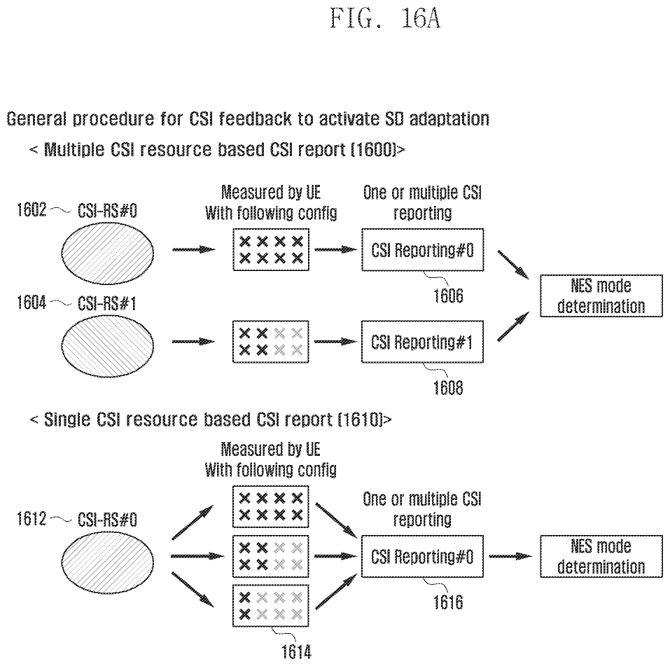

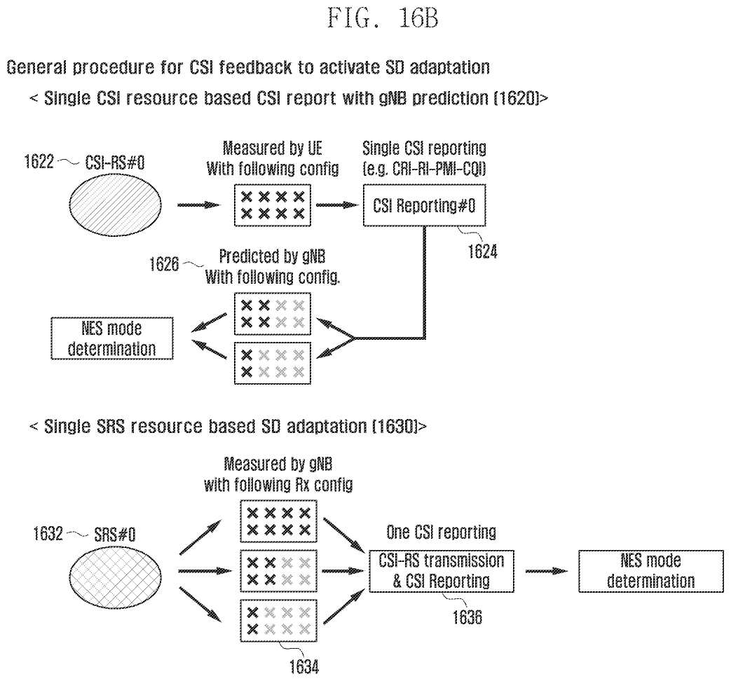

FIG. 16A is a diagram illustrating an example in which a base station receives an SRS or receives CSI feedback for each terminal to determine SD adaptation of the base station according to an embodiment of the disclosure.

### Method 1

Method 1 describes a multiple CSI reporting method via multiple CSI-RS measurements for energy saving of a base station.

Referring to FIG. 16A, a base station may configure 1600, for a terminal via higher-layer signaling, (a single CSI report configuration or) multiple CSI report configurations and multiple CSI resources (hereinafter, a CSI resource may be understood as an NZP CSI-RS resource/resource set, an SSB set, a CSI-IM resource/resource set, and the like) having different antenna structures. For example, in operation 1600, CSI-RS #0 1602 and CSI-RS #1 1604 having different numbers of antenna ports have been configured. In this case, for CSI feedback 1606 and 1608 generated by measuring different CSI-RSs, respectively, the terminal may perform CSI reporting via different PUCCHs or PUSCHs or the same PUCCH or PUSCH. In this case, each CSI feedback may be generated and reported based on each CSI report configuration. Then, the base station may determine SD adaptation for energy saving via the multiple CSI reports.

Method 1 may enable the base station to receive CSI feedback for multiple SD adaptations, and is an appropriate method to make a determination on Type 2 SD adaptation in which antenna ports are adapted to have different RF characteristics. However, since the base station needs to perform CSI-RS transmission and CSI report reception multiple times, and also needs to configure each CSI resource and CSI reporting, configuration overhead and resource utilization overhead may occur. In addition, measurement and reporting overhead on the terminal side may be large.

### Method 2

Method 2 corresponds to a multiple CSI reporting method via single CSI-RS measurement for energy saving of a base station. The base station may configure 1610, for a terminal via higher-layer signaling, a CSI report configuration 1616 having multiple antenna structure configurations and a single-CSI resource configuration 1612 for SD adaptation. In this case, the base station may transmit a single CSI-RS to receive CSI feedback for SD adaptation. The CSI-RS may be a CSI-RS corresponding to a single CSI report configuration or multiple CSI report configurations. In this case, the terminal may perform measurement 1614 multiple times for the single CSI-RS by hypothesizing and considering various antenna structures and CSI-RS patterns, based on the configured CSI report configuration. For example, the terminal measures CSI-RS #0 transmitted by the base station, by considering various numbers of antenna ports (or antenna structures). Then, the terminal may report, via one or more PUCCHs or PUSCHs, measurement results obtained via multiple antenna structure hypotheses. The base station may apply appropriate SD adaptation to the terminal, based on the CSI report from the terminal.

Method 2 may enable the base station to determine SD adaptation for energy saving, and may be particularly applied for Type 1 SD adaptation in which RF characteristics of an antenna port remain the same. In addition, single CSI-RS transmission may enable the base station to reduce overhead for CSI-RS transmission. However, for the terminal, overhead of having to perform CSI reporting by considering various antenna patterns may occur.

FIG. 16B is a diagram illustrating another example in which a base station receives an SRS or receives CSI feedback for each terminal to determine SD adaptation of the base station according to an embodiment of the disclosure.

### Method 3

Method 3 corresponds to a CSI feedback prediction method in consideration of multiple antenna structures of a base station for energy saving of the base station.

Referring to FIG. 16B, the base station may configure, for a terminal via higher-layer signaling, a single CSI resource configuration 1622 and a single CSI report configuration 1624 for SD adaptation, in operation 1620. Then, the base station may receive a CSI report from the terminal, based on the configured information. In this case, the base station may perform CSI reporting prediction by considering various antenna patterns, based on the received CSI report. That is, the terminal may report CSI feedback based on a single CSI resource (CSI-RS #0), and the base station may predict 1626 CSI feedback for various antenna patterns, based on the CSI feedback. Based on this, the base station may determine a terminal-specific antenna pattern of SD adaptation for energy saving.

In method 3, the CSI report received from the terminal may include new channel state information (e.g., full or partial channel matrix) etc. Based on the method, configuration and measurement overhead for CSI reports of both the base station and the terminal may be reduced.

### Method 4

Method 4 corresponds to an SD adaptation method via SRS measurement for energy saving of a base station. The base station may configure 1630, for a terminal via higher-layer signaling, a single SRS resource or multiple SRS resources 1632 for SD adaptation. In this case, the terminal may transmit an SRS according to configuration information. Then, the base station may determine 1634 antenna patterns for SD adaptation via single SRS measurement. As another method, the base station may determine the antenna patterns for SD adaptation by performing multiple SRS measurements respectively based on different Rx antenna patterns. In addition, the base station may transmit a CSI-RS via the determined antenna pattern, receive CSI reporting based on the transmitted CSI-RS from the terminal, and re-identify whether the determined antenna pattern is appropriate, in operation 1636. Based on the re-identification, when an L1-RSRP and/or CQI of the reported CSI report is low (e.g., equal to or lower than/lower than a specific threshold), the base station may perform fallback to SD adaptation having a full antenna pattern. Otherwise (when the L1-RSRP and/or CQI of the reported CSI report is not low (e.g., equal to or higher than/higher than a specific threshold)), the base station may apply SD adaptation (for each terminal) by using an antenna pattern determined in advance via SRS measurement. The base station may determine an antenna pattern for SD adaptation for each terminal via the SRS measurement.

The method is a method in consideration of reciprocity between a DL and a UL in a TDD situation, wherein the base station may determine SD adaptation only by SRS reception without transmission of an additional CSI resource (e.g., CSI-RS) and CSI feedback, so as to have better energy efficiency. However, terminal overhead due to additional SRS configuration and transmission may be a problem.

Via the methods, the base station may receive or identify CSI feedback for applying SD adaptation for each terminal.

Hereinafter, a description will be provided for a method for energy saving of a base station, in which the base station performs CSI resource/resource set/report configuration for determining SD adaptation, based on CSI feedback for each terminal. The base station may perform CSI resource/resource set/report configuration to determine an appropriate antenna pattern for SD adaptation for each terminal by using one of or a combination of the following methods.

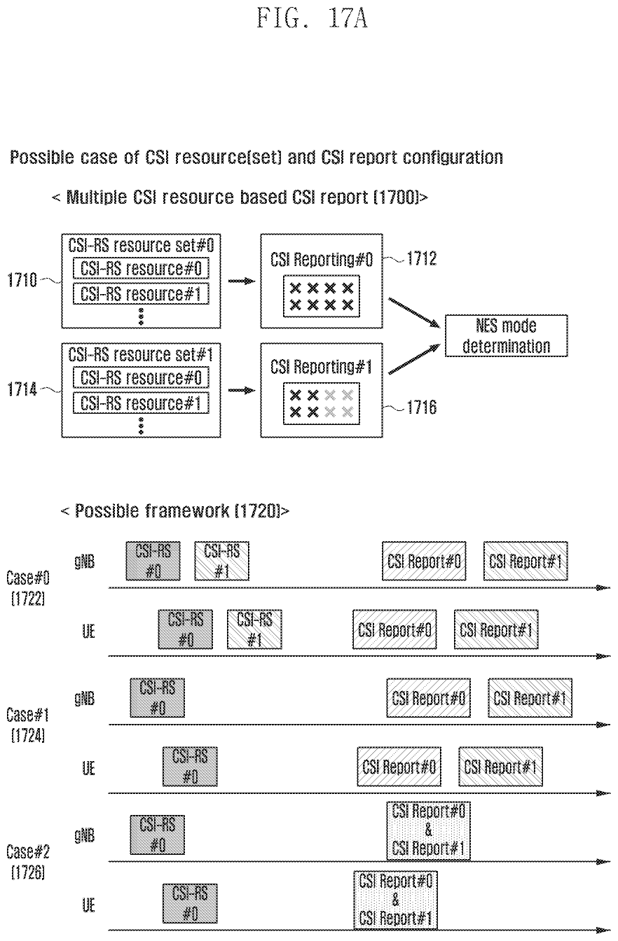

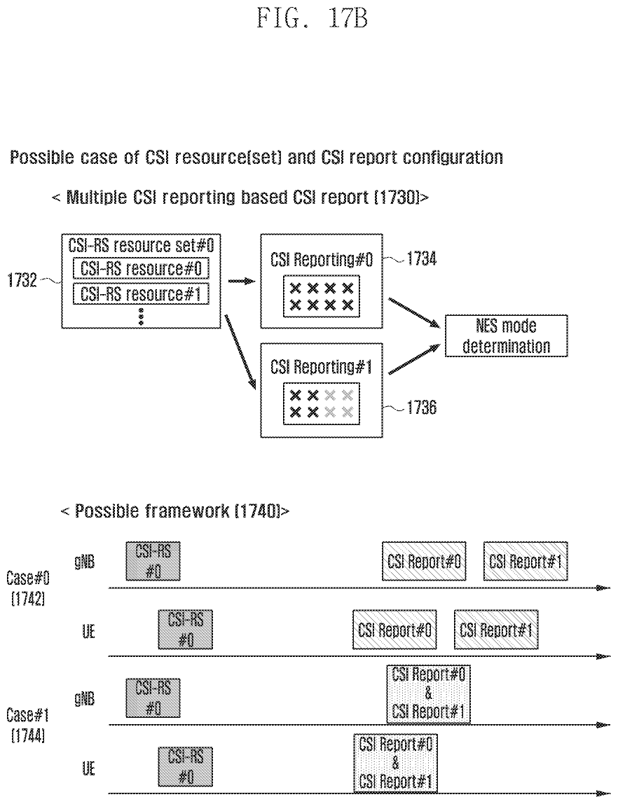

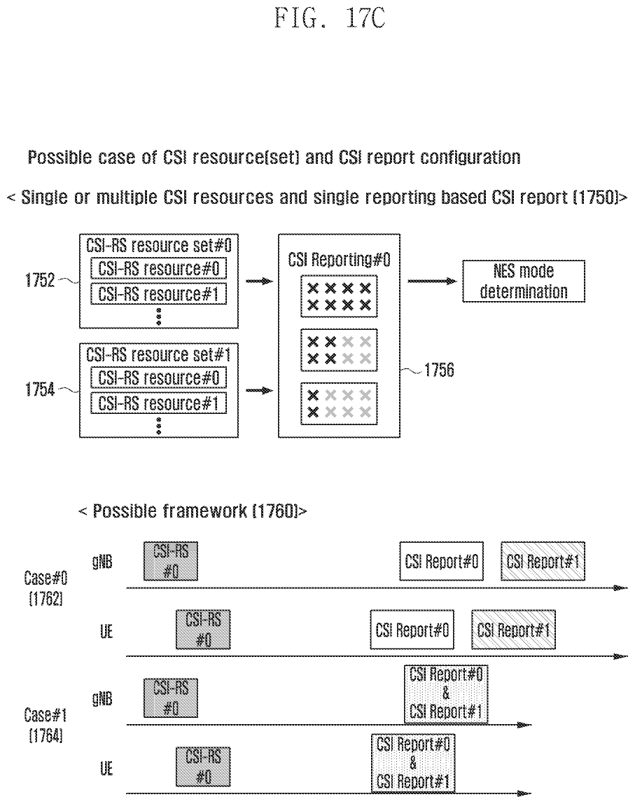

FIG. 17A is a diagram illustrating an example of possible CSI resource/resource set and CSI report configuration according to an embodiment of the disclosure.

### Method 1

Method 1 describes a method of configuring multiple CSI-RS resources/resource sets and multiple CSI reports for energy saving of a base station.

Referring to FIG. 17A, for CSI reports, a base station may configure 1700 multiple CSI resources/resource sets and multiple CSI reports for the CSI resource sets via higher-layer signaling. For example, CSI-RS resource set #0 1710 and CSI-RS resource set #1 1714 is configured, and it is configured so that CSI reporting #0 1712 is performed based on CSI-RS resource set #0 1710, and CSI reporting #1 1716 is performed based on CSI-RS resource set #1 1714. In this case, the base station may perform 1720 the following operations via multiple CSI resources/resource sets and multiple CSI report configurations.

### Operation 1—Case #0

Operation 1 1722 illustrates an operation of, based on multiple CSI resources/resource sets and multiple CSI report configurations, performing CSI-RS transmission/measurement in different resources and performing CSI reporting via a PUCCH/PUSCH. The base station may configure, for a terminal, multiple CSI resources/resource sets and multiple CSI reports via higher-layer signaling. Then, the base station may transmit CSI-RSs having different CSI-RS patterns (e.g., different CDM groups) in different time/frequency resources, respectively. The terminal may perform, via different PUCCHs/PUSCHs, CSI reporting of respective CSI measurement values generated by measuring the CSI-RSs, which are transmitted from the base station, according to CSI report configurations, respectively.

### Operation 2—Case #1

Operation 2 1724 illustrates an operation of, based on multiple CSI resources/resource sets and multiple CSI report configurations, performing CSI-RS transmission/measurement in the same resource, respectively, and performing CSI reporting via different PUCCHs/PUSCHs. The base station may configure, for a terminal, multiple CSI resources/resource sets and multiple CSI reports via higher-layer signaling. Then, the base station may transmit CSI-RSs having the same CSI-RS pattern (e.g., different CDM groups) in the same resource. The terminal may respectively perform, via different PUCCHs/PUSCHs, CSI reporting of multiple CSI measurement values generated by measuring the CSI-RSs, which are transmitted from the base station, based on information of multiple CSI report configurations.

### Operation 3—Case #2

Operation 3 1726 illustrates an operation of, based on multiple CSI resources/resource sets and multiple CSI report configurations, performing single CSI-RS transmission/measurement and performing CSI reporting via a single PUCCH/PUSCH. The base station may configure, for a terminal, multiple CSI resources/resource sets and multiple CSI reports via higher-layer signaling. Then, the base station may transmit CSI-RSs having the same CSI-RS pattern (e.g., different CDM groups) in the same resource. The terminal may perform, via a single PUCCH/PUSCH, CSI reporting of multiple CSI measurement values generated by measuring the single CSI-RS, which is transmitted from the base station, based on information of multiple CSI report configurations.

Via the operations, the base station may receive CSI reports, based on multiple CSI resources/resource sets and multiple CSI report configurations.

FIG. 17B is a diagram illustrating another example of possible CSI resource/resource set and CSI report configuration according to an embodiment of the disclosure.

### Method 2

Method 2 describes a method of configuring a single CSI-RS resource/resource set and multiple CSI reports for energy saving of a base station.

Referring to FIG. 17B, for CSI reports, a base station may configure 1730 a single CSI resource/resource set and multiple CSI reports for the CSI resource set via higher-layer signaling. For example, CSI-RS resource set #0 1732 is configured, and CSI reporting #0 1734 and CSI reporting #1 1736 are configured to be performed based on CSI-RS resource set #0 1732. In this case, respective CSI reporting may be configured to measure CSI-RSs by hypothesizing different antenna patterns or antenna structures. In this case, the base station may perform the following operations 1740 via a single CSI resource/resource set and multiple CSI report configurations.

### Operation 1—Case #0 1742

Operation 1 1742 illustrates an operation of, based on a single CSI resource/resource set and multiple CSI report configurations, performing CSI-RS transmission/measurement in the same resource, respectively, and performing CSI reporting via different PUCCHs/PUSCHs. The base station may configure, for a terminal, a single CSI resource/resource set and multiple CSI reports via higher-layer signaling. Then, the base station may transmit CSI-RSs having the same CSI-RS pattern (e.g., different CDM groups) in the same resource. In this case, the terminal may respectively perform, via different PUCCHs/PUSCHs, CSI reporting of multiple CSI measurement values generated by measuring the CSI-RSs, which are transmitted from the base station, according to respective CSI report configurations.

### Operation 2—Case #1 1744

Operation 2 1744 illustrates an operation of, based on a single CSI resource/resource set and multiple CSI report configurations, performing single CSI-RS transmission/measurement and performing CSI reporting via a single PUCCH/PUSCH. The base station may configure, for a terminal, a single CSI resource/resource set and multiple CSI reports via higher-layer signaling. Then, the base station may transmit CSI-RSs having the same CSI-RS pattern (e.g., different CDM groups) in the same resource. The terminal may perform, via a single PUCCH/PUSCH, CSI reporting of multiple CSI measurement values generated by measuring the single CSI-RS, which is transmitted from the base station, based on information of multiple CSI report configurations.

Via the operations, the base station may receive CSI reports, based on multiple CSI resources/resource sets and multiple CSI report configurations.

FIG. 17C is a diagram illustrating another example of possible CSI resource/resource set and CSI report configuration according to an embodiment of the disclosure.

### Method 3

Method 3 describes a method of, for energy saving of a base station, configuring a single CSI resource/resource set and a single CSI report having multiple antenna structure hypotheses.

Referring to FIG. 17C, for CSI reports, a base station may configure 1750, via higher-layer signaling, a single CSI resource/resource set (or multiple CSI resources/resource sets) and configure a single CSI report having multiple antenna structure hypotheses for the CSI resource/resource set. For example, CSI-RS resource set #0 1752 and CSI-RS resource set #1 1754 are configured, and CSI reporting #0 1756 is configured to be performed based on CSI-RS resource set #0 1752 and CSI-RS resource set #1 1754. In this case, CSI reporting may be configured to measure one or multiple CSI-RS resource sets by hypothesizing multiple antenna patterns or antenna structures. In this case, the base station may perform 1760 the following operations via the single CSI resource/resource set (or multiple CSI resources/resource sets) and the CSI report configuration having multiple antenna structure hypotheses.

### Operation 1—Case #0 1762

Operation 1 1762 illustrates an operation of, based on a single CSI resource/resource set and a single CSI report configuration having multiple antenna structure hypotheses, performing CSI-RS transmission/measurement in the same resource, respectively, and performing CSI reporting via different PUCCHs/PUSCHs. The base station may configure, for a terminal, a single CSI resource/resource set and a CSI report having multiple antenna structure hypotheses via higher-layer signaling. Then, the base station may transmit CSI-RSs having the same CSI-RS pattern (e.g., different CDM groups) in the same resource. In this case, the terminal may respectively perform, via different PUCCHs/PUSCHs, CSI reporting of multiple CSI measurement values generated by measuring the CSI-RSs, which are transmitted from the base station, according to information of multiple CSI report configurations (e.g., the CSI report configuration having different antenna structure hypotheses).

### Operation 2—Case #1 1764

Operation 2 1764 illustrates an operation of, based on a single CSI resource/resource set and a single CSI report configuration having multiple antenna structure hypotheses, performing single CSI-RS transmission/measurement, and performing CSI reporting via a single PUCCH/PUSCH. The base station may configure, for a terminal, a single CSI resource/resource set and a CSI report having multiple antenna structure hypotheses via higher-layer signaling. Then, the base station may transmit CSI-RSs having the same CSI-RS pattern (e.g., different CDM groups) in the same resource. The terminal may perform, via a single PUCCH/PUSCH, CSI reporting of multiple CSI measurement values generated by measuring the single CSI-RS, which is transmitted from the base station, based on information of multiple CSI report configurations (e.g., antenna structure hypotheses). In operation 2, the base station may perform transmission via one or more PUCCHs/PUSCHs by considering a size of the CSI report generated based on multiple antenna structure hypotheses. For example, if the size of the CSI report is greater than a specific threshold, transmission is performed via one or more PUCCHs/PUSCHs, and if the size of the CSI report is smaller than the specific threshold, transmission is performed via a single PUCCH/PUSCH.

Via the operations, the base station may obtain CSI reports, based on multiple CSI resources/resource sets and multiple CSI report configurations.

For method 3, for energy saving of the base station, a method of CSI report configuration indication for determining SD adaptation may be configured via the following configurations.

### Configuration 1

Configuration 1 illustrates a method in which the base station configures, for an RRC connected terminal, CSI report configuration information for SD adaptation determination for energy saving.

For energy saving, the base station may configure, for an RRC connected/inactive terminal, CSI report configuration information for SD adaptation determination. For example, CodebookConfig of CSI-reportConfig as shown below is configured via RRC signaling.

```
TABLE 10
CodebookConfig ::= SEQUENCE {
CodebookConfig-r18 ::= SEQUENCE {
  AdaptationType CHOICE {Type 1, Type 2},
Active_duration INTEGER (1..31),
NES-Threshold CHOICE {rsrp-Threshold, CQI index},
Type2-SD-Adaptation {
    PowerControlOffsetSS ENUMERATED {db-3, db0, db3, db6},
typeII-r16 SEQUENCE {
Multi-n1-n2-codebookSubsetRestriction-r16 ENUMERATED {
two-one BIT STRING (SIZE (16)),
two-two BIT STRING (SIZE (43)),
four-one BIT STRING (SIZE (32)),
three-two BIT STRING (SIZE (59)),
...
},
Nrofmulti-n1-n2-codebook ENUMERATED {1, 2, 3, 4},...
}
...
```

Via the CodebookConfig RRC configuration, the CSI report of the base station, which has multiple antenna structure hypotheses, for SD adaptation may be configured during an NES mode. In this case, information on an SD adaptation type, active_duration information for applying of measurement based on the multiple antenna structure hypotheses, NES-Threshold for selective determination of an antenna structure from among the multiple antenna structure hypotheses, a PowerControlOffsetSS value, and Nrofmulti-n1-n2-codebook which is the number of CSI reports that may be CSI reported from among the multiple antenna structure hypotheses may be configured as new information. The RRC values described above are an example and may be configured in various ways.

Via the methods described above, the base station may reduce energy consumption. In addition, the methods may be configured concurrently via one or more combinations.

In order to reduce energy consumption of a base station, embodiments of the disclosure provide a method in which a base station and a terminal determine a CSI reference resource of a CSI report for CSI feedback reception from the terminal in order to apply SD adaptation and PD adaptation during SD adaptation and PD adaptation, and a method for determining a CQI table and a power control offset for CQI calculation of a CSI report. Based on this, the base station may obtain an appropriate CSI reference resource and an appropriate CQI during SD adaptation & PD adaptation for energy saving, so as to save energy of the base station.

### First Embodiment

As the first embodiment of the disclosure, proposed is a method in which a base station determines a CSI reference resource for a duration of applying SD adaptation and PD adaptation for energy saving or a CSI reference resource for a CSI report for applying SD adaptation and PD adaptation.

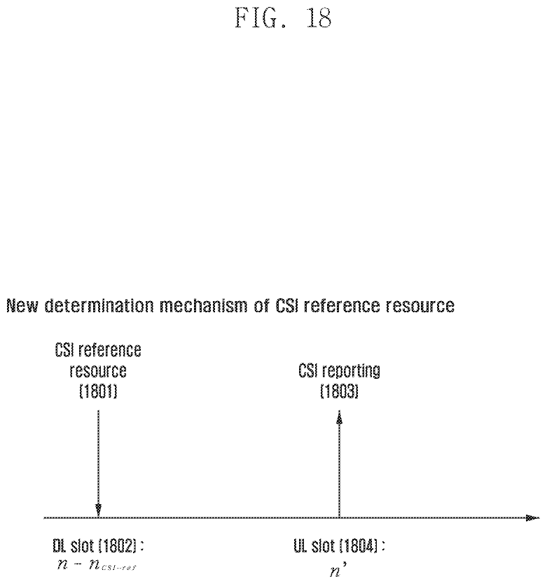

FIG. 18 is a diagram illustrating an example of a method of determining a CSI reference resource by a base station and a terminal according to an embodiment of the disclosure.

More specifically, a base station and a terminal may determine a CSI reference resource according to a periodic (P), semi-persistent (SP), or aperiodic (AP) CSI report as follows.

P/SP CSI report

Referring to FIG. 18, a terminal or a base station may transmit a CSI report 1803 in uplink slot n′ 1804 on the time axis. In this case, a CSI reference resource 1801 and downlink slot 1802 for the CSI report 1803 may be defined as

$$n - {n}_{CSI \_ ref} - {K}_{offset} \times \frac{{2}^{{μ}_{DL}}}{{2}^{{μ}_{offset ′}}} .$$

In this case, K_{offset} may be configured via higher-layer signaling for a non-terrestrial network (NTN, which may be interchangeably used with satellite network communication), μ_{offset} is a sub-carrier spacing value for K_{offset}, and

$$n = ⌊ {n}^{′} \times \frac{{2}^{{μ}_{DL}}}{{2}^{{μ}_{DL}}} ⌋ + \vert ( \frac{{N}_{slot , offset , UL}^{CA}}{{2}^{{μ}_{offset , UL}}} - \frac{{N}_{slot , offset , DL}^{CA}}{{2}^{{μ}_{offset , DL}}} ) \times {2}^{{μ}_{DL}} \vert$$

may be determined. In this case, when a non-CA situation of a terrestrial network (TN, which may be interchangeably used with terrestrial network communication) is considered, simplification may be performed so that n=n′. In the equipment, for periodic and semi-persistent CSI reporting, the terminal or the base station may determine n_{CSI_ref} as follows.
If one CSI-RS/SSB resource is configured for channel measurement, n_{CSI_ref} is a minimum value greater than or equal to 4×2^{μDL} to correspond to a valid downlink slot. Alternatively,
If multiple CSI-RS/SSB resources are configured for channel measurement, n_{CSI_ref} is a minimum value greater than or equal to 5×2^{μDL} to correspond to a valid downlink slot.

By using the equation value, the terminal and the base station may determine the CSI reference resource in a normal operation other than an energy saving mode of the base station.

In this case, when the CSI report for SD adaptation & PD adaptation operation or determination for NES described above is configured, the terminal or the base station may determine n_{CSI_ref} as follows by combining one or more of the methods below.

When the base station indicates the terminal to transmit a specific CSI report in UL slot n′ via higher-layer signaling or DCI, the terminal may report CSI feedback by performing channel measurement or interference measurement on a CSI resource transmitted or located no later than the CSI reference resource of the CSI report transmitted in UL slot n′ among CSI resources associated with the CSI report.

### Method 1

For energy saving of the base station, when the base station requests CSI feedback, based on a CSI resource/resource set/report configured to operate or determine SD adaptation and PD adaptation, the terminal and base station may determine n_{CSI_ref} as follows.
If one CSI-RS/SSB resource is configured for channel measurement, n_{CSI_ref} is a minimum value greater than or equal to 4×2^{μDL} to correspond to a valid downlink slot. Alternatively,
If multiple CSI-RS/SSB resources are configured for channel measurement, n_{CSI_ref} is a minimum value greater than or equal to 5×2^{μDL}+K_{NES} to correspond to a valid downlink slot.

For a CSI report based on hypotheses (hypothesized antenna structure or antenna pattern) of N multiple CSI-RS resources/resource sets or M multiple spatial elements (or antenna elements) configured via higher-layer signaling (RRC), the K_{NES} may be a time offset required for the terminal to perform CSI-RS measurement and processing for a CSI report. For example, K_{NES}=N*M*K_{offset,NES} is expressed, where K_{offset,NES} may be a value configured by the base station via higher-layer signaling, a value determined by UE capability, or a predetermined value. In addition, the equation is an example, does not limit the scope of the disclosure, and may be expressed as K_{NES}×2^{μDL}, and the like. Via the method, the base station and the terminal may accurately determine a CSI reference resource when multiple measurements and CSI processing are required for SD adaptation & PD adaptation for energy saving of the base station.

### Method 2

For energy saving of the base station, when the base station requests CSI feedback, based on a CSI resource/resource set/report configured to operate or determine SD adaptation and PD adaptation, the terminal and base station may determine n_{CSI_ref} as follows.
If one CSI-RS/SSB resource is configured for channel measurement, n_{CSI_ref} is a minimum value greater than or equal to 4×2μ^{DL}+K_{NES} to correspond to a valid downlink slot. Alternatively,
If multiple CSI-RS/SSB resources are configured for channel measurement, n_{CSI_ref} is a minimum value greater than or equal to 5×2μ^{DL}+K′_{NES} to correspond to a valid downlink slot.

For a CSI report based on hypotheses of one or N multiple CSI-RSs or M multiple spatial elements (or antenna elements) configured via higher-layer signaling (RRC), the K_{NES} may be a time offset required for the terminal to perform CSI-RS measurement and processing for a CSI report. For example, K_{NES}=N*M*K_{offset,NES} is expressed, where K_{offset,NES} may be a value configured by the base station via higher-layer signaling, a value determined by UE capability, or a predetermined value. In addition, the equation is an example, does not limit the scope of the disclosure, and may be expressed as K_{NES}×2μ^{DL}, and the like.

K′_{NES} and K_{NES} may have the same value applied thereto, and may be determined differently depending on the number of associated CSI reports or hypotheses of multiple spatial element (or antenna elements) of a CSI report associated with each CSI-RS of multiple CSI-RSs. For example, as shown in K_{NES}=N*M*K_{offset,NES} corresponding to a CSI-RS resource associated with CSI resource/resource set/report configuration A or K′_{NES}=N′*M′ *K_{offset,NES} corresponding to multiple CSI-RS resources associated with CSI resource/resource set/report configuration B, configuration is performed differently. Via the method, when multiple measurements and CSI processing are required for SD adaptation & PD adaptation for energy saving of the base station, the base station and the terminal may calculate 4×2^{μDL}+K_{NES} or 5×2^{μDL}+K′_{NES} based on the configured number of CSI-RSs and provide a CSI reference resource.

### Method 3

For energy saving of the base station, when the base station requests CSI feedback, based on a CSI resource/resource set/report configured to operate or determine SD adaptation and PD adaptation, the terminal and base station may determine n_{CSI_ref} as follows.
If one or multiple CSI reports are configured for NES, n_{CSI_ref} is a minimum value greater than or equal to 5×μ^{μDL} to correspond to a valid downlink slot.

As in the above method, for a CSI report based on hypotheses of N multiple CSI-RSs or M multiple spatial elements (or antenna elements) for NES, 5×2^{μDL} may always be applied as a time offset required for the terminal to perform CSI-RS measurement and processing for the CSI report. Via the method, the base station and the terminal may accurately determine a CSI reference resource when multiple measurements and CSI processing are required for SD adaptation & PD adaptation for energy saving of the base station.

Via the method, the base station and the terminal may determine a CSI reference resource according to a periodic(P)/semi-persistent(SP) CSI report as follows.

AP CSI report

Referring to FIG. 18, a terminal or a base station may transmit a CSI report 1803 in uplink slot n′ 1804 on the time axis. In this case, a CSI reference resource for the CSI report 1803 may be defined as

$$n - {n}_{CSI \_ ref} - {K}_{offset} \times \frac{{2}^{{μ}_{DL}}}{{2}^{{μ}_{offset ′}}} .$$

In this case, K_{offset} may be configured via higher-layer signaling for an NTN, μ_{offset} is a sub-carrier spacing value for K_{offset}, and

$$n = ⌊ {n}^{′} \times \frac{{2}^{{μ}_{DL}}}{{2}^{{μ}_{DL}}} ⌋ + ⌊ ( \frac{{N}_{slot , offset , UL}^{CA}}{{2}^{{μ}_{offset , UL}}} - \frac{{N}_{slot , offset , DL}^{CA}}{{2}^{{μ}_{offset , DL}}} ) \times {2}^{{μ}_{DL}} ⌋$$

may be determined. In this case, when a non-CA situation of TN is considered, simplification may be performed so that n=n′. In the equipment, for AP CSI reporting, the terminal or the base station may determine n_{CSI_ref} as follows.
If the terminal is indicated, via DCI, to transmit a CSI report in the same slot as a slot in which a CSI request is located (i.e., a slot in which the DCI has been received), n_{CSI_ref} is a minimum value greater than or equal to └Z′/N_{symb}^{slot}┘ so that a CSI reference resource corresponds to a valid downlink slot. Z′ may be determined based on reportQuantity configured via higher-layer signaling according to Tables 11 and 12 below.

TABLE 11

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

TABLE 12

| | | |
|---|---|---|
| Z₁ [symbols] | Z₂ [symbols] | Z₃ [symbols] |

| μ | Z₁ | Z′₁ | Z₂ | Z′₂ | Z₃ | Z′₃ |
|---|---|---|---|---|---|---|
| 0 | 22 | 16 | 40 | 37 | 22 | X₀ |
| 1 | 33 | 30 | 72 | 69 | 33 | X₁ |
| 2 | 44 | 42 | 141 | 140 | min(44, | X₂ |
| | | | | | X₂ + KB₁) | |
| 3 | 97 | 85 | 152 | 140 | min(97, | X₃ |
| | | | | | X₃ + KB₂) | |
| 5 | 388 | 340 | 608 | 560 | min(388, | X5 |
| | | | | | X5 + KB3) | |
| 6 | 776 | 680 | 1216 | 1120 | min(776, | X6 |
| | | | | | X6 + KB4) | |

By using the equation value, the terminal and the base station may determine the CSI reference resource in the normal operation other than the energy saving mode of the base station.

In this case, when the CSI report for SD adaptation & PD adaptation operation or determination for NES described above is configured, the terminal or the base station may determine n_{CSI_ref} as follows by combining one or more of the methods below.

### Method 1

For energy saving of the base station, when the base station requests CSI feedback, based on a CSI resource/resource set/report configured to operate or determine SD adaptation and PD adaptation, the terminal and base station may determine n_{CSI_ref} as follows.
If the terminal is indicated, via DCI, to transmit a CSI report in the same slot as a slot in which the DCI has been received, n_{CSI_ref} is a minimum value greater than or equal to n_{CSI_ref}+K_{NES} so that a CSI reference resource corresponds to a valid downlink slot. Z′ may be determined based on reportQuantity configured via higher-layer signaling according to Tables 11 and 12 above.

For a CSI report based on hypotheses of N multiple CSI-RSs or M multiple spatial elements (or antenna elements), K_{NES} may be a time offset required for the terminal to perform CSI-RS measurement and processing for the CSI report. For example, K_{NES}=N*M*K_{offset,NES} may be expressed, where K_{offset,NES} is a value configured by the base station via higher-layer signaling, a value determined by UE capability, or a predetermined value. In addition, the equation is an example, does not limit the scope of the disclosure, and may be expressed as K_{NES}×2μ^{DL}, and the like. Via the method, when multiple measurements and CSI processing are required for SD adaptation & PD adaptation for energy saving of the base station, the base station and the terminal may calculate n_{CSI_ref} based on the configured number of CSI-RSs.

### Method 2

For energy saving of the base station, when the base station requests CSI feedback, based on a CSI resource/resource set/report configured to operate or determine SD adaptation and PD adaptation, the terminal and base station may determine n_{CSI_ref} as follows.
If the terminal is indicated, via DCI, to transmit a CSI report in the same slot as a slot in which the DCI has been received, n_{CSI_ref} is a minimum value greater than or equal to └Z′/N_{symb}^{slot}┘ so that a CSI reference resource corresponds to a valid downlink slot. Z′ is max(Z₁, Z′₁, Z₂, Z′₂, Z₃, Z′₃) and is a maximum value among values of Z₁, Z′₁, Z₂, Z′₂, Z₃, and Z′₃ which may be determined based on reportQuantity configured by higher-layer signaling according to Tables 11 and 12 above. For example, in Tables 11 and 12 above, if a p value is 0, Z₂ is determined as “40”.

Via the method, when multiple measurements and CSI processing are required for SD adaptation & PD adaptation for energy saving of the base station, the base station and the terminal may calculate n_{CSI_ref} based on the configured number of CSI-RSs.

Via the methods, the base station and the terminal may determine a CSI reference resource according to an aperiodic CSI report.

### Second Embodiment

As the second embodiment of the disclosure, proposed is a method for determining a CQI for a CSI report for a duration of applying SD adaptation and PD adaptation for energy saving by a base station or for determining a CQI for a CSI report for applying SD adaptation and PD adaptation. An embodiment of the disclosure provides a method of determining a CQI according to a power control offset or a target block error rate (BLER) during an energy saving operation of a base station.

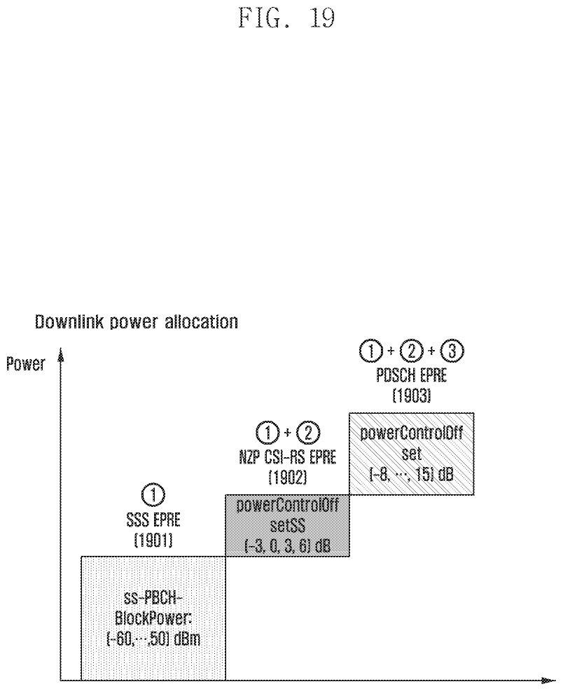

FIG. 19 is a diagram illustrating a method of determining a PDSCH transmission power via a power control offset by a terminal according to an embodiment of the disclosure.

Referring to FIG. 19, a terminal may receive an energy per resource element (EPRE) value for a transmission power of an SSS of an SSB from a base station via higher-layer signaling ss-PBCH-BlockPower 1901, and configure same. Then, in order to calculate a transmission power of a non-zero power (NZP) CSI-RS, the terminal may receive higher-layer signaling powerControlOffsetSS from the base station, and may be configured with a difference in the transmission power between the SSS and the NZP CSI-RS. The terminal may determine the transmission power of the NZP CSI-RS to be ss-PBCH-BlockPower 1901+powerControlOffsetSS 1902. Then, in order to calculate a transmission power of a PDSCH, the terminal may receive higher-layer signaling powerControlOffset from the base station, and may be configured with a difference in the transmission power between the NZP CSI-RS and the PDCSH. The terminal may determine the transmission power of the PDSCH to be ss-PBCH-BlockPower 1901+powerControlOffsetSS 1902+powerControlOffset 1903.

Then, the terminal may determine a CQI via data capacity or an SINR (signal to interference plus noise ratio) obtained based on the transmission power of the PDSCH configured via internal implementation.

When the base station determines whether to continue to apply SD adaptation and PD adaptation for energy saving while SD adaptation and PD adaptation are being applied, or configures a CSI report to determine whether to apply SD adaptation and PD adaptation, the terminal may determine a CQI as in the following cases via the newly configured ss-PBCH-BlockPower, powerControlOffsetSS, and powerControlOffset. When the base station configures a duration of applying SD adaptation and PD adaptation for energy saving or a CSI report for applying SD adaptation and PD adaptation, at least one powerControlOffset or at least one powerControlOffsetSS may be configured for a corresponding CSI resource.

In this case, the terminal may determine the PDSCH transmission power as follows for the configured CSI report.

### Case1-1

When the base station configures a duration of applying SD adaptation and PD adaptation for energy saving or a CSI report for applying SD adaptation and PD adaptation, a multi powerControlOffset {P₁, P₂, P₃} and a single powerControlOffsetSS {P′₁} may be configured by CSI resource configuration information for configuring the CSI resource. Then, the terminal may report, via the CSI report, CQI₁, CQI₂, and CQI₃ determined via P₁+P′₁, P₂+P′₁, and P₃+P′₁. The multi powerControlOffset may be configured in consideration of PD adaptation or SD adaptation type 2.

### Case1-2

When the base station configures a duration of applying SD adaptation and PD adaptation for energy saving or a CSI report for applying SD adaptation and PD adaptation, a single powerControlOffset {P₁} and a multi powerControlOffsetSS {P′₁, P′₂, P′₃} may be configured in CSI resource configuration information for configuring the CSI resource. Then, the terminal may report, via the CSI report, CQI₁, CQI₂, and CQI₃ determined via P₁+P′₁, P₁+P′₂, and P₁+P′₃. The multi powerControlOffsetSS may be configured in consideration of PD adaptation or SD adaptation type 2.

### Case1-3

When the base station configures a duration of applying SD adaptation and PD adaptation for energy saving or a CSI report for applying SD adaptation and PD adaptation, a multi powerControlOffset {P₁, P₂, P₃} and a multi powerControlOffsetSS {P′₁, P′₂, P′₃} may be configured for the CSI resource. Then, the terminal may report, via the CSI report, CQI₁, CQI₂, and CQI₃ determined via P₁+P′₁, P₂+P′₂, and P₃+P′₃.

Via the cases above, the terminal may determine the power control offset and calculate the CQI. The above methods are examples, and thus do not limit the disclosure, and when the multi powerControlOffset {P₁, P₂, P₃} and the multi powerControlOffsetSS {P′₁, P′₂, P′₃} are configured, a total of up to 9 CQIs may be reported in combination of {P₁, P₂, P₃} *{P′₁, P′₂, P′₃}.

The disclosure provides a method of determining a CQI according to a target BLER during an energy saving operation of a base station. During a normal operation, the base station may configure cqi-Table via higher-layer signaling (CSI-ReportConfig). In this case, a transport block error probability (BLER) of a single PDSCH transport block having a TBS, a target code rate, and an MCS according to a specific CQI index does not exceed a specific value according to cqi-Table as follows:
If Cqi-Table is configured to be table1, table2, and table4-r17, the BLER does not exceed 0.1.
If cqi-Table is configured to be table3, the BLER does not exceed 0.00001.

When the base station configures a duration of applying SD adaptation and PD adaptation for energy saving or a CSI report for applying SD adaptation and PD adaptation, the base station may determine a target BLER to be a value lower than 0.1 for energy saving. Therefore, a transport block error probability (BLER) of a single PDSCH transport block having a TBS, a target code rate, and an MCS calculated with a newly obtained CQI index during the energy saving mode of the base station may be determined as follows.
If cqi-Table is configured to be table1, table2, and table4-r17, the BLER does not exceed X.
If cqi-Table is configured to be table3, the BLER does not exceed X′.

In this case, X and X′ may be the same value, and X and X′ may be a predetermined value, may be a value according to UE capability, or may be a value determined according to higher-layer signaling.

As another method, when the base station configures a duration of applying SD adaptation and PD adaptation for energy saving or a CSI report for applying SD adaptation and PD adaptation, a target BLER may be determined to be a value lower than 0.1 for energy saving. Therefore, the base station may always use table 1, table2, and table4-r17 as cqi-Table for NES, and a transport block error probability (BLER) of a single PDSCH transport block having a TBS, a target code rate, and an MCS calculated with a newly obtained CQI index during the energy saving mode of the base station may be determined as follows.
If cqi-Table is configured to be table1, table2, and table4-r17, the BLER does not exceed X.

X may be a predetermined value, may be a value according to UE capability, or may be a value determined according to higher-layer signaling.

As in the methods above, when a base station applies SD adaptation or PD adaptation for energy saving, a terminal may calculate a CQI via the above method. In this case, the energy saving mode is not limited to SD adaptation or PD adaptation, and various schemes, such as cell DTX/DRX and on-demand SSB, may be considered.

### Third Embodiment

The third embodiment of the disclosure provides an example of a transmission and reception procedure in which a base station calculates a CSI reference resource and a CQI for a duration of applying SD adaptation and PD adaptation for energy saving or a CSI reference resource and a CQI for a CSI report for applying SD adaptation and PD adaptation.

In various embodiments, a method for reducing energy consumption of a base station by the base station in a wireless communication system may include configuring CSI reports and CSI resource(set)s having a power control offset and multiple antenna configuration hypotheses for SD & PD adaptation for energy saving of a base station via higher-layer signaling, determining, based on the configured information, a CSI report configuration among the multiple antenna configuration hypotheses, determining a CSI reference resource for a CSI report transmitted from a terminal, determining a power control offset and a CQI table for CQI calculation of the CSI report, and then applying SD & PD adaptation, based on the CSI report from the terminal.

In various embodiments, a method for reducing energy consumption of a base station by a terminal in a wireless communication system may include being configured with CSI reports and CSI resource(set)s having a power control offset and multiple antenna configuration hypotheses for SD & PD adaptation for energy saving of a base station via higher-layer signaling, determining, based on the configured information, a CSI report configuration among the multiple antenna configuration hypotheses, determining, based on configuration information from the base station, a CSI reference resource for a CSI report, determining, based on the configuration information, a power control offset and a CQI table for CQI calculation of the CSI report, and then transmitting the CSI report to the base station.

More specifically, descriptions will be provided for flowcharts and block diagrams of a terminal and a base station, for CSI reference resource and CQI calculation.

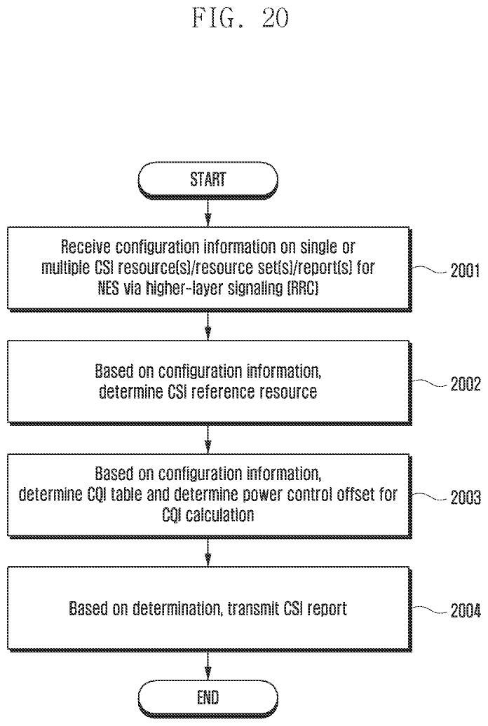

FIG. 20 is a diagram illustrating an example of a terminal operation of applying an energy saving method of the 5G system, to which the disclosure is applied according to an embodiment of the disclosure.

Referring to FIG. 20, a terminal may receive, from a base station, CSI configuration information required for an SD adaptation or PD adaptation operation for energy saving of the base station. The CSI configuration information may be configuration information on a single or multiple CSI resource(s)/resource set(s)/report(s) via higher-layer signaling (e.g., RRC signaling), in operation 2001. Based on the configured information, the terminal may determine a CSI reference resource for the CSI report, in operation 2002. Then, the terminal may perform CSI measurement using the configured CSI reference resource, determine a power control offset for CSI processing, based on the configured information, and determine a CQI table for CQI calculation, in operation 2003. Then, the terminal may transmit the CSI report including the determined CQI value, in operation 2004.

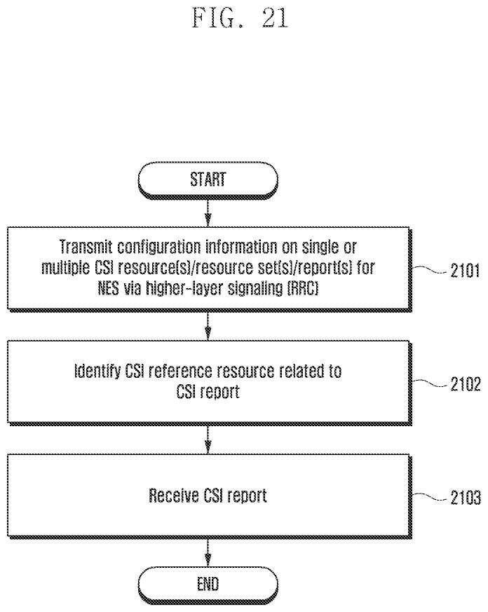

FIG. 21 is a diagram illustrating an example of a base station operation of applying an energy saving method of the 5G system, to which the disclosure is applied according to an embodiment of the disclosure.

Referring to FIG. 21, a base station may transmit, to a terminal, CSI configuration information required for an SD adaptation or PD adaptation operation for energy saving of the base station. The CSI configuration information may be configuration information on a single or multiple CSI resource(s)/resource set(s)/report(s) via higher-layer signaling (e.g., RRC signaling), in operation 2101. Based on the configured information, a CSI reference resource related to the CSI report may be identified in operation 2102. The base station may determine that the terminal has performed CSI measurement using the configured CSI reference resource, has determined a power control offset for CSI processing, based on the configured information, and has used a CQI table for CQI calculation. The base station may receive the CSI report including a CQI value from the terminal, in operation 2103.

The above flowcharts illustrate example methods that may be implemented in accordance with the principles of the disclosure, and various changes may be made to the methods illustrated in the flowcharts herein. For example, while shown as a series of operations, various operations in each figure may overlap, occur in parallel, occur in a different order, or occur multiple times. In another example, operations may be omitted or replaced by other operations.

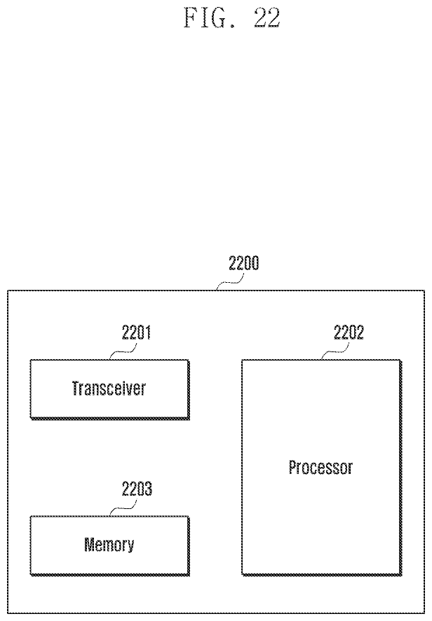

FIG. 22 is a block diagram of a terminal according to an embodiment of the disclosure.

Referring to FIG. 22, a terminal 2200 may include a transceiver 2201, a controller (e.g., a processor) 2202, and a storage unit (e.g., memory) 2203. The transceiver 2201, the controller 2202, and the storage unit 2203 of the terminal 2200 may operate according to at least one or a combination of methods corresponding to the aforementioned embodiments. However, the elements of the terminal 2200 are not limited to the described examples. According to another embodiment, the terminal 2200 may include more or fewer elements compared to the aforementioned elements. In addition, in a specific case, the transceiver 2201, the controller 2202, and the storage unit 2203 may be implemented in the form of a single chip.

The transceiver 2201 may include a transmitter and a receiver according to an embodiment. The transceiver 2201 may transmit signals to or receive signals from a base station. The signal may include control information and data. The transceiver 2201 may include an RF transmitter configured to perform amplification and up-conversion of a frequency of a transmitted signal, and an RF receiver configured to perform low-noise amplification of a received signal and perform down-conversion of a frequency. The transceiver 2201 may receive a signal via a radio channel, output the signal to the controller 2202, and transmit, via the radio channel, a signal output from the controller 2202.

The controller 2202 may control a series of procedures in which the terminal 2200 may operate according to the aforementioned embodiments of the disclosure. For example, the controller 2202 performs or control a terminal operation for performing at least one or a combination of methods according to the embodiments of the disclosure. The controller 2202 may include at least one processor. For example, the controller 2202 includes a communication processor (CP) configured to perform control for communication and an application processor (AP) configured to control a higher layer (e.g., an application).

The storage unit 2203 may store control information (e.g., information on channel estimation using DMRSs transmitted on a PUSCH included in a signal acquired by the terminal 2200) or data, and may have an area for storing data required for controlling of the controller 2202 and data generated during controlling in the controller 2202.

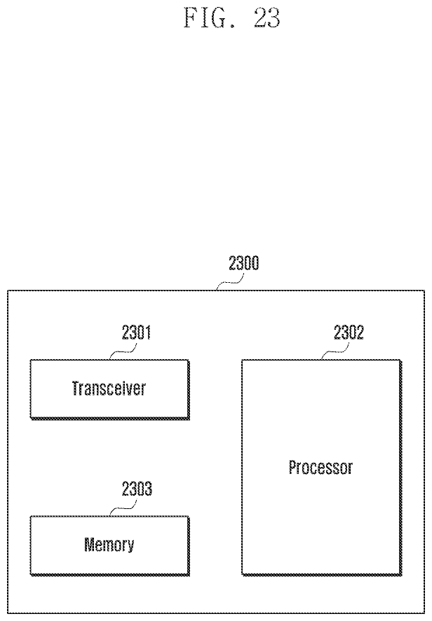

FIG. 23 is a block diagram of a base station according to an embodiment of the disclosure.

Referring to FIG. 23, a base station 2300 may include a transceiver 2301, a controller (e.g., a processor) 2302, and a storage unit (e.g., memory) 2303. The transceiver 2301, the controller 2302, and the storage unit 2303 of the base station 2300 may operate according to at least one or a combination of methods corresponding to the aforementioned embodiments. However, the elements of the base station 2300 are not limited to the described examples. According to another embodiment, the base station 2300 may include more or fewer elements compared to the aforementioned elements. In addition, in a specific case, the transceiver 2301, the controller 2302, and the storage unit 2303 may be implemented in the form of a single chip.

The transceiver 2301 may include a transmitter and a receiver according to an embodiment. The transceiver 2301 may transmit signals to or receive signals from a terminal. The signal may include control information and data. The transceiver 2301 may include an RF transmitter configured to perform amplification and up-conversion of a frequency of a transmitted signal, and an RF receiver configured to perform low-noise amplification of a received signal and perform down-conversion of a frequency. The transceiver 2301 may receive a signal via a radio channel, output the signal to the controller 2302, and transmit, via the radio channel, a signal output from the controller 2302.

The controller 2302 may control a series of procedures so that the base station 2300 may operate according to the aforementioned embodiment of the disclosure. For example, the controller 2302 performs or controls a base station operation for performing at least one or a combination of methods according to the embodiments of the disclosure. The controller 2302 may include at least one processor. For example, the controller 2302 includes a communication processor (CP) configured to perform control for communication and an application processor (AP) configured to control a higher layer (e.g., an application).

The storage unit 2303 may store control information (e.g., information on channel estimation, which is generated using DMRSs transmitted on a PUSCH determined by the base station 2300) or data thereof, and control information or data received from a terminal, and may have an area for storing data required for controlling by the controller 2302 and data generated during controlling by the controller 2302.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal, the method comprising:
receiving, by the terminal from a base station, channel state information (CSI) report configuration information including a configuration on a CSI report for a network energy saving, a power offset for the CSI report for the network energy saving being included in the configuration on the CSI report for the network energy saving;
obtaining, by the terminal, a channel quality indicator (CQI) based on the power offset; and
transmitting, by the terminal to the base station, a CSI report including the CQI.

2. The method of claim 1, wherein the power offset corresponds to a subset of channel state information reference signal (CSI-RS) resources for the CSI report for network energy saving.

3. The method of claim 2, wherein information on the subset of CSI-RS resources is included in the configuration on the CSI report for the network energy saving.

4. The method of claim 1, wherein the CQI is obtained based on both the power offset for the CSI report for the network energy saving and a power control offset configured for a channel state information reference signal (CSI-RS) resource.

5. The method of claim 1, wherein the power offset for the CSI report for the network energy saving is applied to a difference between an energy per resource element (EPRE) of a channel state information reference signal (CSI-RS) and an EPRE of a physical downlink shared channel (PDSCH).

6. A method performed by a base station, the method comprising:
receiving, by the base station to a terminal, channel state information (CSI) report configuration information including a configuration on a CSI report for a network energy saving, a power offset for the CSI report for the network energy saving being included in the configuration on the CSI report for the network energy saving; and
receiving, by the base station from the terminal, a CSI report including a channel quality indicator (CQI),
wherein the CQI is based on the power offset.

7. The method of claim 6, wherein the power offset corresponds to a subset of channel state information reference signal (CSI-RS) resources for the CSI report for network energy saving.

8. The method of claim 7, wherein information on the subset of CSI-RS resources is included in the configuration on the CSI report for the network energy saving.

9. The method of claim 6, wherein the CQI is based on both the power offset for the CSI report for the network energy saving and a power control offset configured for a channel state information reference signal (CSI-RS) resource.

10. The method of claim 6, wherein the power offset for the CSI report for the network energy saving is applied to a difference between an energy per resource element (EPRE) of a channel state information reference signal (CSI-RS) and an EPRE of a physical downlink shared channel (PDSCH).

11. A terminal, comprising:
transceivers;
memory storing one or more computer programs; and
one or more processors communicatively coupled to the transceivers and the memory,
wherein the one or more computer programs include computer-executable instructions that, when executed by the one or more processors, cause the terminal to:
receive, from a base station, channel state information (CSI) report configuration information including a configuration on a CSI report for a network energy saving, a power offset for the CSI report for the network energy saving being included in the configuration on the CSI report for the network energy saving, and
obtain a channel quality indicator (CQI) based on the power offset, and transmit, to the base station, a CSI report including the CQI.

12. The terminal of claim 11, wherein the power offset corresponds to a subset of channel state information reference signal (CSI-RS) resources for the CSI report for network energy saving.

13. The terminal of claim 12, wherein information on the subset of CSI-RS resources is included in the configuration on the CSI report for the network energy saving.

14. The terminal of claim 11, wherein the CQI is obtained based on both the power offset for the CSI report for the network energy saving and a power control offset configured for a channel state information reference signal (CSI-RS) resource.

15. The terminal of claim 11, wherein the power offset for the CSI report for the network energy saving is applied to a difference between an energy per resource element (EPRE) of a channel state information reference signal (CSI-RS) and an EPRE of a physical downlink shared channel (PDSCH).

16. A base station, comprising:
transceivers;
memory storing one or more computer programs; and
one or more processors communicatively coupled to the transceivers and the memory,
wherein the one or more computer programs include computer-executable instructions that, when executed by the one or more processors, cause the base station to:
receive, to a terminal, channel state information (CSI) report configuration information including a configuration on a CSI report for a network energy saving, a power offset for the CSI report for the network energy saving being included in the configuration on the CSI report for the network energy saving, and
receive, from the terminal, a CSI report including a channel quality indicator (CQI),
wherein the CQI is based on the power offset.

17. The base station of claim 16, wherein the power offset corresponds to a subset of channel state information reference signal (CSI-RS) resources for the CSI report for network energy saving.

18. The base station of claim 17, wherein information on the subset of CSI-RS resources is included in the configuration on the CSI report for the network energy saving.

19. The base station of claim 16, wherein the CQI is based on both the power offset for the CSI report for the network energy saving and a power control offset configured for a channel state information reference signal (CSI-RS) resource.

20. The base station of claim 16, wherein the power offset for the CSI report for the network energy saving is applied to a difference between an energy per resource element (EPRE) of a channel state information reference signal (CSI-RS) and an EPRE of a physical downlink shared channel (PDSCH).
